(19) United States
(12) Patent Application Publication
(10) Pub. No.: US 2026/0289183 A1
(43) Pub. Date: Sep. 24, 2026

(54) SYSTEM

(71) Applicant: SoftBank Group Corp., Tokyo (JP)

(72) Inventor: Mikiko TAKEUCHI, Tokyo (JP)

(73) Assignee: SoftBank Group Corp., Tokyo (JP)

(21) Appl. No.: 19/567,368

(22) Filed: Mar. 16, 2026

(30) Foreign Application Priority Data
Mar. 19, 2025 (JP) 2025-045250

(51) Int. Cl. G06F 40/40; G06F 40/166; G06F 40/263; G06F 40/284; G06F 40/30

(52) U.S. Cl. CPC G06F 40/40; G06F 40/166; G06F 40/263; G06F 40/284; G06F 40/30

(57) ABSTRACT

A system includes a processor that is configured to receive information via an interface that receives information from a user, analyze the received information by using a generative AI model and evaluate legal concerns, security impacts, and customer reactions, generate a prompt for sorting the information to appropriate departments based on a result of the analysis, use an emotion analysis technique to analyze an emotional state of the user, and generate a prompt for setting a priority of the information based on the emotional state.

### CROSS-REFERENCE TO RELATED APPLICATION

This application is based on and claims priority under 35 USC 119 from Japanese Patent Application No. 2025-045250 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information routing and case-handling systems in enterprises typically rely on manual triage by human operators or on simple rule-based engines that consider only limited aspects of incoming information, such as keywords or pre-defined categories. As a result, such systems often fail to accurately evaluate complex contextual factors, including potential legal concerns, security impacts, and anticipated customer reactions associated with the information. This can lead to misrouting of cases to inappropriate departments, delayed responses to legally or security-sensitive matters, and suboptimal handling of issues that may significantly affect customer satisfaction and trust.

Furthermore, existing systems generally do not consider the emotional state of the user who submits the information. In many business and customer support scenarios, the emotional state of the user can be a critical indicator of urgency and potential reputational risk. However, without automated emotion analysis and corresponding prioritization, highly urgent or sensitive communications may be processed with the same priority as routine inquiries, resulting in delayed resolution and decreased customer satisfaction. Accordingly, there is a need for a system that can automatically analyze incoming information using advanced artificial intelligence, evaluate legal, security, and customer-reaction-related risks, and further analyze the emotional state of the user to automatically generate prompts for appropriate routing and prioritization.

### SUMMARY

To solve the above-described problems, a system is provided that comprises a processor configured to receive information via an interface that receives information from a user, analyze the received information by using a generative AI model, and evaluate legal concerns, security impacts, and customer reactions. The processor is further configured to generate, based on a result of the analysis, a prompt for sorting the information to appropriate departments, thereby supporting accurate and context-aware routing of the information within an organization.

In addition, the processor is configured to use an emotion analysis technique to analyze an emotional state of the user and to generate a prompt for setting a priority of the information based on the emotional state. In one aspect, the processor is configured to generate, by using the generative AI model, a prompt for automatically determining a related department from contents of the information so that the information can be efficiently assigned without relying solely on pre-defined rules. In another aspect, the processor is configured to generate a prompt for preferentially sorting the information based on the emotional state of the user, thereby enabling the system to treat emotionally urgent or sensitive communications with higher priority. Through these configurations, the system achieves improved accuracy and responsiveness in information routing and prioritization, while taking into account legal, security, customer reaction, and emotional factors in an integrated manner.

The term “system” refers to a combination of hardware and software components that cooperate to perform the functions described in the claims, including at least one processor and any associated memory, interfaces, and programs.

The term “processor” refers to any device or combination of devices that is capable of executing instructions, including but not limited to a central processing unit (CPU), a microprocessor, a graphics processing unit (GPU), a digital signal processor (DSP), a microcontroller, a field-programmable gate array (FPGA) configured to execute instructions, or a combination thereof.

The term “interface” refers to a hardware and/or software component that enables the exchange of information between the user and the system, including but not limited to graphical user interfaces, web interfaces, application programming interfaces (APIs), communication ports, and input/output devices.

The term “user” refers to any human operator, customer, client, or other person who provides information to the system or interacts with the system through the interface.

The term “information” refers to any data, text, message, inquiry, complaint, request, document, or other content that is submitted by the user via the interface and processed by the system.

The term “generative AI model” refers to an artificial intelligence model that is capable of generating output data, such as text, prompts, or other content, based on input information, and includes, for example, large language models, sequence-to-sequence models, and other neural network-based generative models.

The term “analysis” refers to the processing of input information by the system, including operations such as parsing, classification, extraction of features, evaluation of context, inference, and generation of intermediate or final outputs.

The term “legal concerns” refers to potential issues, risks, or requirements related to laws, regulations, contracts, compliance obligations, or legal policies that may be implicated by the content of the information.

The term “security impacts” refers to potential effects on the confidentiality, integrity, or availability of data, systems, or services, including risks of unauthorized access, data leakage, data tampering, system outages, or other security-related events.

The term “customer reactions” refers to anticipated or inferred responses, attitudes, satisfaction levels, acceptance, or rejection by customers or end users in relation to the content of the information or to actions that may be taken based on the information.

The term “prompt” refers to data generated by the processor that provides instructions, recommendations, guidance, or cues to another system, subsystem, or human operator, and that is used to support sorting, routing, prioritization, or other processing of the information.

The term “sorting the information” refers to classifying, routing, or assigning the information to one or more destinations, such as departments, teams, queues, or processing pipelines, for further handling.

The term “appropriate departments” refers to organizational units, teams, or functional groups within an entity that are relevant to or responsible for handling the content of the information, such as legal, security, customer support, sales, or technical departments.

The term “emotion analysis technique” refers to any algorithm or model that is configured to infer or estimate the emotional state of the user from the information provided, from associated metadata, or from other user signals, including but not limited to sentiment analysis, emotion classification, or affective computing methods.

The term “emotional state” refers to an estimated or inferred psychological or affective condition of the user, such as anger, frustration, satisfaction, anxiety, urgency, or other emotions, as determined by the emotion analysis technique.

The term “priority of the information” refers to an order, ranking, level, or degree of urgency assigned to the information by the system for the purpose of determining processing order, response speed, allocation of resources, or escalation level.

The term “related department” refers to a department or organizational unit that is determined, based on contents of the information and one or more models or rules, to be suitable for handling or responding to the information.

The term “preferentially sorting” refers to sorting, routing, or handling the information in such a manner that information with higher priority or higher urgency is processed, delivered, or addressed before or with greater emphasis than information with lower priority.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

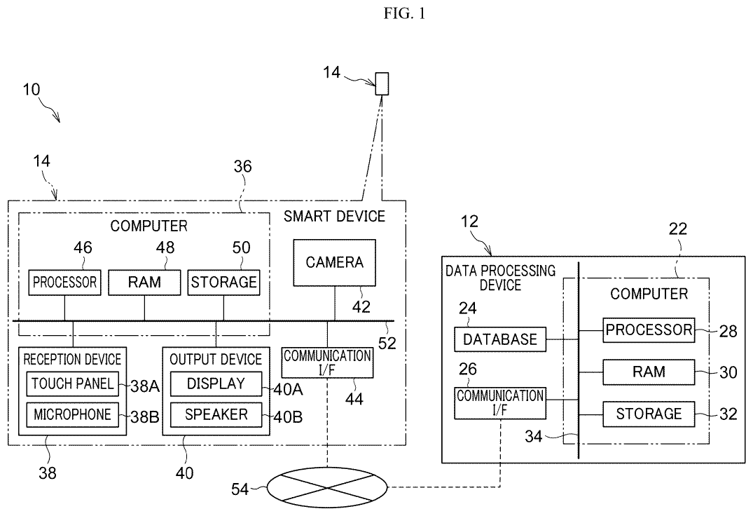

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

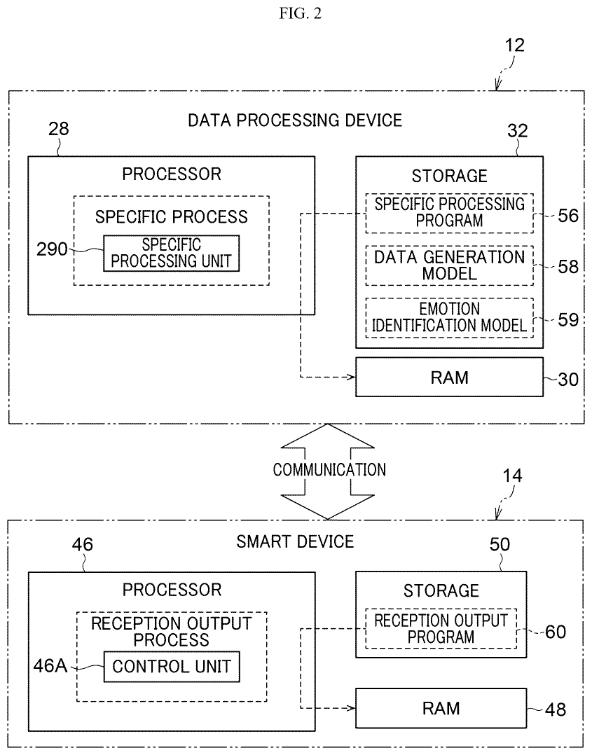

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented drafting tools and workflow systems are primarily designed as simple data collection and routing mechanisms. In such systems, a processor typically receives unstructured user input, performs limited keyword-based analysis, and forwards the information to predetermined destinations. These systems exhibit several technical limitations in terms of information processing efficiency, utilization of machine learning resources, and adaptability of processing logic.

First, when a processor simply forwards user input to a generative artificial intelligence model without generating a context-aware prompt, the model must infer constraints, priorities, and objectives from raw text. This leads to increased computational load within the generative model, redundant inference cycles, and generation of outputs that lack structural consistency. As a result, additional post-processing is required on the server side, consuming processor time and memory resources, and causing increased latency in end-to-end processing.

Second, known systems do not systematically integrate heterogeneous data sources-such as external legal information, internal records, and market data-into a unified, structured representation before interacting with a generative model. Without prior generation of structured information representing legal matters, information protection impact, user reactions, and business opportunities, the processor cannot effectively control which elements are emphasized in the model input. This reduces the controllability and predictability of the output, often requiring manual trial-and-error prompt engineering by users, which is inefficient from a computational and operational standpoint.

Third, existing architectures typically treat generative model inference as a monolithic operation over an entire document or case context. When the user wishes to refine only a portion of a generated proposal, the whole proposal is often regenerated. This leads to unnecessary repeated processing on the generative model, increases network traffic between the server and the model provider, and causes redundant storage operations on the server. Such inefficiency directly impacts system throughput and responsiveness, particularly in multi-user environments where processor and memory resources are shared.

Fourth, conventional systems lack mechanisms by which the processor dynamically adjusts prompt construction and model input conditions based on user modifications and importance scores computed from structured analysis. The absence of such feedback-driven adaptation prevents the system from learning and optimizing its own prompt generation logic. Consequently, the processor repeatedly performs generic, non-optimized prompt generation, which can degrade the quality of machine-generated content and reduce the effective utilization of computational resources.

Therefore, there is a need for an improved computer-implemented system in which a processor: (i) performs multi-stage natural language processing to generate structured representations of heterogeneous case-related information; (ii) derives context information and importance scores to construct targeted, constraint-aware prompt sentences; (iii) cooperates with a generative artificial intelligence model in a way that minimizes redundant processing while maintaining structured, high-quality outputs; and (iv) supports incremental, section-level regeneration of proposal documents and adaptive adjustment of prompts based on user feedback. Such a system would improve the technical functioning of the server as an information processing apparatus by reducing computational waste, improving response time, and increasing the reliability and controllability of generative outputs.

The specific processing by the specific processing unit 290 of the data processing device 12 in Example 1 is realized by the following means.

The present invention provides a server comprising a processor configured to receive case-related request information from a user via an input/output interface; acquire, via a communication interface, heterogeneous case-related information from external and internal information sources; store the acquired case-related information in a storage unit as an integrated data set; preprocess textual information included in the data set using natural language processing software to generate structured information including at least legal matters, information protection impact, user reactions, and business opportunities; generate context information and importance scores from the structured information; construct, based on the request information, the context information, and the importance scores, a prompt sentence serving as a generation instruction text for a generative artificial intelligence model, the prompt sentence being configured to instruct generation of a proposal document in a risk-reducing and advantage-maximizing manner; cause the generative artificial intelligence model to operate using the prompt sentence and the context information as inputs to obtain generated information including the proposal document; store the generated information in association with a case; transmit the generated information to a terminal device for user viewing and editing; receive modification information from the terminal device; update the proposal document based on the modification information; adjust at least one of the prompt sentence and input conditions to the generative artificial intelligence model based on the modification information; and, in some embodiments, automatically divide the proposal document into sections, generate local prompt sentences targeting individual sections, and perform partial regeneration of specific sections using the generative artificial intelligence model. This enables an improvement in the operation of the computer system by reducing redundant computation and network usage associated with generative model calls, increasing the structural consistency and relevance of generated proposal documents through context-aware prompt construction, and providing an efficient incremental update mechanism that allows the processor to refine only necessary portions of a document while adaptively optimizing prompt generation based on structured analysis and user feedback.

The term “processor” refers to a hardware computation unit or a combination of hardware computation units that execute instructions, perform logical and arithmetic operations, and control data flows to implement the functions described in the present disclosure.

The term “input/output interface” refers to a hardware and software interface through which the processor exchanges data with external devices, including but not limited to user terminals and communication networks, and which may include communication circuits, buses, and interface software.

The term “request information” refers to information input by a user to define a case, including at least a purpose of the case, a target area or domain, and one or more constraint conditions relevant to processing of the case.

The term “case-related information” refers to information that pertains to the case defined by the request information and that includes, for example, legal system information, market information, internal records, and past case information obtained from external and internal information sources.

The term “external information source” refers to an information system, database, or service located outside the server's internal environment, accessible via a communication network, and providing data such as legal texts, regulations, or public market data.

The term “internal information source” refers to an information system, database, or repository located within an organization operating the server, and providing data such as internal policies, past project records, contracts, and customer feedback.

The term “integrated data set” refers to a collection of case-related information that has been aggregated, normalized, and associated with a specific case such that the data can be processed together by the processor.

The term “storage unit” refers to a hardware memory device or a combination of memory devices, such as volatile memory, non-volatile memory, and external storage, used to store programs, integrated data sets, structured information, generated information, and other data.

The term “textual information” refers to information represented in natural language text form, including characters, words, sentences, and paragraphs, regardless of language.

The term “natural language processing software” refers to software components or libraries that perform analysis and transformation of natural language text, including at least segmentation, part-of-speech tagging, phrase extraction, classification, and other linguistic or semantic processing.

The term “segmentation” refers to a process of dividing textual information into units such as sentences, clauses, or tokens so that the units can be individually analyzed.

The term “part-of-speech tagging” refers to a process of assigning grammatical categories, such as noun, verb, adjective, and adverb, to individual tokens within textual information.

The term “phrase extraction” refers to a process of identifying and extracting multi-word expressions or phrases, such as noun phrases and key terms, that are semantically or syntactically significant in the textual information.

The term “classification” refers to a process of assigning one or more categories or labels to units of textual information based on their content, such as classifying segments into legal matters, information protection impact, user reactions, or business opportunities.

The term “structured information” refers to information that has been organized into a predefined form, such as records, fields, or hierarchies, representing results of natural language processing including at least legal matters, information protection impact, user reactions, and business opportunities.

The term “legal matters” refers to issues, requirements, or constraints related to laws, regulations, rules, or contractual obligations that are applicable to the case.

The term “information protection impact” refers to effects of the case on the confidentiality, integrity, and availability of information, including risks and mitigation measures related to information security and privacy.

The term “user reactions” refers to responses, opinions, sentiments, or feedback of end users or customers regarding products, services, or scenarios associated with the case.

The term “business opportunities” refers to potential advantages, revenue sources, market openings, or strategic benefits that may arise from the case.

The term “context information” refers to information derived from structured information that summarizes and highlights key points relevant to the case, including at least key legal matters, key information protection impact, and key user reactions and market conditions, and that is used to guide generation by a generative model.

The term “importance score” refers to a value computed by the processor that represents a degree of significance or priority of an element such as a legal matter, information protection impact, or user reaction within the structured information.

The term “prompt sentence” refers to a natural language instruction text generated by the processor and provided as input to a generative artificial intelligence model to guide the content, structure, and focus of generated outputs.

The term “generation instruction text” refers to a text that instructs a generative artificial intelligence model regarding what content to generate, under what constraints, and with what objectives, and that may specify structure, tone, and emphasis.

The term “generative artificial intelligence model” refers to a machine learning model, such as a neural network, that generates new text or other content based on input data, including at least a prompt sentence and associated context information.

The term “generated information” refers to information created by the generative artificial intelligence model in response to a prompt sentence and context information, and including at least a proposal document.

The term “proposal document” refers to a machine-generated document that proposes actions, measures, or strategies for the case while taking into account legal matters, information protection impact, user reactions, and business opportunities.

The term “terminal device” refers to a computing device operated by a user, such as a personal computer, mobile device, or any other client device, that communicates with the server to send request information and display generated information.

The term “modification information” refers to information representing changes, corrections, additions, or deletions that a user makes to a proposal document or other generated information through a terminal device.

The term “input conditions to the generative artificial intelligence model” refers to control parameters, settings, or additional inputs, including but not limited to temperature values, output length limits, and context selection, that influence behavior of the generative artificial intelligence model.

The term “section” refers to a discrete part of a proposal document, such as a chapter, heading, or itemized element, that can be individually stored, edited, and regenerated.

The term “local prompt sentence” refers to a prompt sentence that is specifically constructed to target generation or regeneration of a particular section or component of a proposal document rather than the entire document.

In one embodiment, a server implements the claimed system by executing a program stored in a storage unit and running on a hardware platform that includes at least one multi-core central processing unit, a main memory, a nonvolatile storage device, and a network interface. The server uses an operating system such as a general-purpose server operating system and uses application software including a database management system, a natural language processing library, and a generative AI client library. The server communicates with one or more terminal devices operated by users via a communication network such as a local area network or a wide area network.

The server uses a database management system, such as a relational database, to store integrated data sets, structured information, context information, generated proposal documents, and user modification information. The server further uses a document-oriented data store in some embodiments to store unstructured or semi-structured text segments associated with each case. The server uses natural language processing libraries such as general-purpose tokenization and part-of-speech tagging tools (for example, libraries commonly used in the Python ecosystem, including a toolkit for natural language processing and a library for statistical and neural language processing) to preprocess textual information.

The server uses a generative AI client library to send prompt sentences and context information to a generative AI model, such as a large-scale transformer-based neural network model (for example, a model similar to a generalized pre-trained transformer), provided by a remote AI service.

The server executes a program that first causes the server to receive case-related request information from a terminal device. The terminal displays input fields for a user to enter information such as a case purpose, a target jurisdiction, and constraint conditions. The user enters information such as “Launch a subscription-based software-as-a-service offering for customers in a specific region with strict data protection regulations.” The terminal sends this request information to the server through a secure communication protocol. The server stores the request information in a case table in the relational database and assigns a unique case identifier.

The server acquires case-related information from external and internal information sources. The server uses the network interface and a communication module to send queries to external information sources such as public legal databases, regulatory guidance repositories, and market research services. The server also accesses internal information sources, including an internal policy repository, an internal contract archive, and a customer feedback database.

The server fetches documents such as statutes, regulatory guidelines, internal policy documents, historical project summaries, and customer survey results, and stores them in an integrated data set associated with the case identifier. The integrated data set is stored in the relational database and in some embodiments indexed in a document store for efficient retrieval.

The server preprocesses textual information included in the integrated data set using natural language processing software. The server loads each document into main memory, converts character encoding into a unified encoding format such as UTF-8, and removes markup, scripts, and non-textual elements. The server applies sentence segmentation to split the text into sentences and tokenization to split sentences into tokens. The server performs part-of-speech tagging and named-entity recognition using a statistical or neural model provided by the natural language processing library. The server then applies phrase extraction to identify noun phrases and key multi-word expressions.

The server classifies text segments into categories such as legal matters, information protection impact, user reactions, and business opportunities. In one embodiment, the server uses a supervised learning classifier such as a logistic regression model or a gradient-boosted decision tree model trained on feature vectors derived from term frequency-inverse document frequency values and word embeddings. In another embodiment, the server uses a transformer-based encoder model fine-tuned on labeled legal and business texts to output classification probabilities for each category. The server stores, for each text segment, a category label, a confidence score, and a reference to the original document.

The server generates structured information by aggregating classification results and extracted phrases. The structured information is stored as records that contain fields such as “legal_issue_summary,” “privacy_impact_summary,” “user_sentiment,” and “business_opportunity_description.” The server also computes importance scores for individual elements. For example, the server calculates an importance score for each legal matter based on a weighted combination of classifier confidence, frequency of occurrence across documents, presence of mandatory language such as “shall” or “must,” and the segment's position within authoritative documents. The server performs similar scoring for information protection impact and user reactions, using features such as severity indicators, sentiment polarity, and relevance to the case purpose.

The server generates context information by summarizing the structured information. In one embodiment, the server uses an extractive summarization algorithm, such as a graph-based ranking algorithm, to select representative sentences from segments labeled as highly important. In another embodiment, the server uses a smaller, domain-specific sequence-to-sequence neural network model to produce abstractive summaries of legal matters, information protection implications, and market and user feedback trends. The context information includes condensed descriptions of key legal obligations, data security requirements, user preferences, and potential business advantages.

The server constructs a prompt sentence to be sent to the generative AI model. The prompt sentence incorporates the case purpose, the target region, and the summarized context information, and may explicitly indicate required output structure. For example, the server may generate a prompt sentence of the following form:
“You are a legal, privacy, and business strategy assistant. Draft a comprehensive proposal for the following case.
Case purpose: Launch a subscription-based SaaS service for customers in a region with strict data protection regulations.
Key legal matters: Data protection law requires explicit consent for personal data processing, restrictions on international data transfers, and clear information on data subject rights. Consumer protection rules require transparent pricing and easy cancellation.
Information protection impact: Customer data will be stored in cloud servers; encryption in transit and at rest is required; availability target is 99.9%.
Customer reactions and market conditions: Previous feedback shows that customers appreciate simple onboarding and clear privacy explanations but react negatively to frequent intrusive consent dialogs. The SaaS market is competitive but growing in small and medium enterprise segments.
Structure the proposal with the following sections:
1) Background,
2) Legal and compliance measures,
3) Information security measures,
4) Customer experience and market strategy,
5) Risk-reduction actions,
6) Business advantage maximization.
Provide concrete action items in each section, explicitly explaining how legal and privacy risks are reduced and how business advantages and customer satisfaction are maximized.”

In another example, the server may generate a localized prompt sentence for partial regeneration of a specific section:

“Revise the ‘Legal and compliance measures’ section of the proposal for the subscription-based SaaS service described above. Make the section more concise while preserving all mandatory regulatory requirements and key risk mitigation measures.”

The server sends the constructed prompt sentence and associated context information to the generative AI model. The generative AI model in one embodiment is a multi-layer transformer network comprising an embedding layer, multiple self-attention layers, feed-forward layers, and a final output projection layer. The model parameters have been trained on a large corpus of text using a pretraining objective such as next-token prediction or masked language modeling. During inference, the server passes the prompt tokens and optional additional context tokens to the model, which computes attention scores and hidden representations and outputs a probability distribution over vocabulary tokens for each position. The server controls generation parameters such as maximum output length, temperature, and top-k or nucleus sampling threshold to adjust diversity and determinism of the generated text.

The server obtains generated information from the generative AI model via an application programming interface, parses the returned text, and stores the generated proposal document in the database, associating it with the case identifier. The server may split the proposal document into sections according to heading markers and store each section as a separate record linked by the case identifier and section type. This section-level storage allows the server to directly access and regenerate specific sections without reprocessing the entire document, thereby reducing computational load and network traffic when refinements are requested.

The server transmits the generated proposal document to the terminal. The terminal displays the sections in a structured format that allows the user to navigate between background, legal measures, information security measures, customer strategy, risk-reduction actions, and advantage maximization. The user reviews the proposed content and enters modifications such as clarifying a regulatory citation, adding an internal policy reference, or adjusting a risk tolerance threshold. The terminal sends the modification information back to the server.

The server updates the stored proposal document based on the received modification information. The server computes differences between the original generated text and the modified text to identify which sections or subsections have been changed by the user. The server uses this information to adjust subsequent prompt generation. For example, if the user repeatedly modifies specific types of statements, such as over-cautious risk warnings, the server updates prompt templates to request more balanced language. The server may maintain a profile of user preferences and incorporate these into future prompt sentences, thereby adapting its behavior over time.

The server modifies input conditions to the generative AI model based on modification information and importance scores. For highly important elements such as mandatory legal obligations or high-impact data protection measures, the server configures the prompt sentence to emphasize these elements and instructs the model not to omit them. The server may also reduce randomness in generation by lowering the temperature for sections that must adhere strictly to regulatory language, thereby improving consistency and reducing errors. For less critical sections, such as optional marketing recommendations, the server may allow more variability.

The server improves technical performance of the computer system by using structured information and context-aware prompt generation to reduce unnecessary interaction with the generative AI model. Because the server preprocesses and classifies documents, identifies key elements, and generates targeted prompt sentences, the model receives focused, constraint-rich input and is less likely to produce irrelevant or incomplete content. This reduces the number of iterations required to obtain an acceptable proposal, saving processor time and decreasing data transfer over the network. The section-level regeneration mechanism further reduces processing, because only the affected sections are regenerated rather than the entire document. This design lowers average response time, decreases memory usage for intermediate representations, and reduces the load on the external AI service.

In one embodiment, the server uses a training subsystem to refine internal classifiers and summarization models. The server collects generated proposal documents, associated structured information, importance scores, and user modification information as training data. The server uses a loss function that combines classification accuracy, summary coverage, and alignment with user edits. The server performs weight updates by applying gradient descent or a variant such as Adam optimization to the parameters of the classifier and summarization models. Data augmentation techniques such as paraphrasing and back-translation may be used to increase diversity of the training corpus. As a result, the internal models become better at identifying important legal and privacy elements and at producing context information that leads to higher-quality generative outputs. This reduces the need for manual prompt engineering and improves consistency across cases, thereby enhancing the technical functioning of the server.

In another embodiment, the server enforces non-conventional rules for handling conflicts between legal matters and business opportunities. For example, when importance scores for a legal constraint and a business opportunity conflict, the server applies a rule hierarchy in which legal compliance is always prioritized, and the prompt sentence is constructed to first satisfy legal requirements and then optimize within remaining degrees of freedom. The server explicitly encodes such rule hierarchies in metadata associated with structured information and uses them when composing prompt sentences. This rule-based integration with machine-learned components represents a non-traditional combination that shifts some decision-making burden from the generative AI model to the server, which can implement deterministic constraints more efficiently and reliably.

In a further embodiment, the server performs caching and reuse of intermediate results. When multiple cases share similar purposes or target regions, the server reuses structured information and context templates for common legal frameworks. By doing so, the server avoids reprocessing identical legal corpora for each case, thereby improving processing speed and reducing storage and network access operations. The server maintains a cache index that maps patterns in request information to existing context templates and stored summaries. When a match is found, the server partially bypasses earlier analysis stages and proceeds directly to prompt construction with appropriate adjustments, improving throughput under high load.

In yet another embodiment, the server controls visualization and interaction on the terminal in a way that supports technical benefits. The server sends metadata such as importance scores, risk levels, and section types along with the proposal text. The terminal uses this metadata to render visual indicators, such as highlighting high-importance legal requirements or flagging sections with uncertain classification. This visualization enables the user to focus attention on technically critical parts, which in turn leads to more targeted modifications. These targeted modifications provide higher-quality feedback for the learning subsystem, closing a loop that further improves the server's processing efficiency and accuracy over time.

Through the integration of multi-stage natural language processing, importance scoring, rule-based prompt construction, structured interaction with a generative AI model, and section-level incremental regeneration, the server achieves improvements in computational efficiency, data management, processing precision, and communication load. The system therefore constitutes more than mere automation of a human document drafting process; it modifies how the computer stores, analyzes, and generates text data in a way that improves the functioning of the computer system itself, particularly in terms of resource utilization and reliability of output.

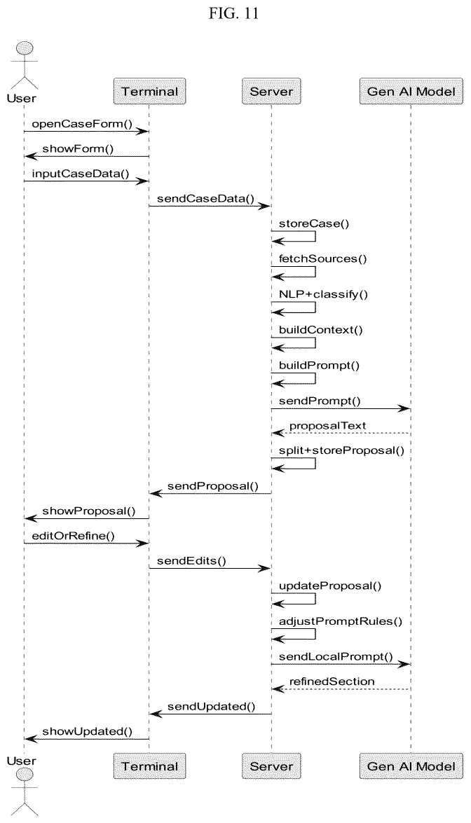

The following describes the processing flow using FIG. 11.

### Step 1:

The terminal displays an input screen for case definition. The terminal presents input fields for a case purpose, a target area, and constraint conditions, and initializes these fields as empty. The input to this step is a user action requesting to start a new case. The output is a populated input form on the terminal screen ready to accept text and selections.

### Step 2:

The user enters case-related request information on the terminal. The user types textual descriptions such as a business goal, a jurisdiction, and risk constraints, and selects options from drop-down menus. The input to this step is the empty or default form displayed by the terminal. The output is a set of user-entered values, represented internally by the terminal as a structured object containing fields such as “case_purpose,” “target_region,” and “constraints.”

### Step 3:

The terminal transmits the request information to the server. The terminal serializes the structured object into a message, attaches a case creation request header, and sends it via a secure communication protocol to the server. The input to this step is the structured object of user inputs. The output is a network message received by the server that contains the case-related request information.

### Step 4:

The server stores the request information and assigns a case identifier. The server decodes the received message, validates required fields, and inserts a new record into a case table in a database, generating a unique case ID. The input to this step is the received request information. The output is a persisted database record linking the case ID with the request information and a confirmation object that references this case ID.

### Step 5:

The server acquires external and internal case-related information. The server reads the case purpose and target region from the database, constructs search queries, and sends these queries to external data sources and internal repositories. The input to this step is the stored request information and connection parameters for various data sources. The output is a collection of raw documents, including legal texts, guidelines, policies, historical project summaries, and customer feedback, each tagged with its source and retrieval metadata.

### Step 6:

The server integrates and stores the acquired documents as an integrated data set. The server normalizes document formats, converts encodings, and associates all collected documents with the case ID. The input to this step is the heterogeneous set of raw documents from multiple sources. The output is an integrated data set stored in a database or document store, consisting of standardized text fields and metadata records for each document.

### Step 7:

The server preprocesses textual information by cleaning and segmenting it. The server loads each document from the integrated data set, removes markup and non-textual content, and performs sentence segmentation and tokenization using natural language processing software. The input to this step is the integrated data set of raw text documents. The output is a set of cleaned and segmented text units, such as sentences and tokens, stored in an intermediate data structure linked to the original documents.

### Step 8:

The server performs linguistic analysis including part-of-speech tagging and phrase extraction. The server applies tagging algorithms from a natural language processing library to assign grammatical categories to tokens and then identifies key noun phrases and multi-word expressions. The input to this step is the segmented text units from Step 7. The output is enriched text units in which each token has associated tags and in which extracted phrases are stored as separate entries with references to their positions in the text.

### Step 9:

The server classifies text segments into predefined categories. The server converts each sentence or paragraph into a feature representation, applies a trained classification model, and assigns one or more labels such as “legal matter,” “information protection impact,” “user reaction,” or “business opportunity.” The input to this step is the enriched text units with tokens and phrases. The output is a labeled set of text segments, each associated with category labels and classification confidence scores.

### Step 10:

The server generates structured information from the labeled text segments. The server aggregates segments by category, groups related phrases, and synthesizes category-specific summaries or key points. The input to this step is the labeled segments with classification metadata. The output is a structured record set containing fields for legal issues, privacy impacts, user sentiment summaries, and business opportunities, each represented as compact textual descriptions linked to the case ID.

### Step 11:

The server computes importance scores for elements in the structured information. The server evaluates each legal issue, privacy impact, and user reaction using criteria such as frequency, classifier confidence, presence of mandatory terms, and correlation with the case purpose, and calculates a numerical score for each element. The input to this step is the structured information produced in Step 10. The output is a weighted structured information set in which each element has an associated importance score.

### Step 12:

The server generates context information by summarizing high-importance elements. The server selects elements with importance scores above a threshold, applies summarization algorithms, and composes concise descriptions of key legal matters, information protection impacts, and user and market conditions. The input to this step is the weighted structured information set. The output is a context object containing summarized text sections that capture the most critical aspects of the case.

### Step 13:

The server constructs a global prompt sentence for full proposal generation. The server reads the request information and context object, inserts the case purpose and summarized constraints into a prompt template, and defines the desired structure of the proposal. The input to this step is the request information and the context object. The output is a global prompt sentence that instructs a generative AI model to produce a multi-section proposal document considering legal matters, information protection impact, and user reactions.

### Step 14:

The server transmits the prompt sentence and context information to the generative AI model. The server converts the prompt sentence and any supplementary context into a sequence of tokens, sets generation parameters such as maximum token length and sampling temperature, and sends these to the generative model's application programming interface. The input to this step is the global prompt sentence and the context object. The output is a request message processed by the generative AI model, which begins inference.

### Step 15:

The server receives and parses the generated proposal document. The server obtains the generated text sequence from the generative AI model, reconstructs the text from tokens, and separates the content into sections according to headings or markers specified in the prompt. The input to this step is the model's response containing generated tokens or text. The output is a structured proposal document, divided into sections such as background, legal measures, information security measures, user strategy, risk reduction, and advantage maximization.

### Step 16:

The server stores the proposal document and section metadata. The server creates database records for the full proposal and for each section, linking each to the case ID and tagging each section with its type. The input to this step is the structured proposal document from Step 15. The output is a persistent representation of the proposal and its sections in the storage system, ready for retrieval and further processing.

### Step 17:

The server sends the proposal document to the terminal for display. The server retrieves the stored proposal sections, formats them into a response message with structural and importance metadata, and transmits the message to the terminal. The input to this step is the stored proposal and section metadata. The output is a network response that enables the terminal to render the proposal content.

### Step 18:

The terminal displays the proposal sections and interaction controls. The terminal interprets the response, arranges the sections in a user interface, and shows metadata such as highlighted key points or risk indicators, while also providing editing tools such as text fields and buttons. The input to this step is the response message received from the server. The output is a graphical display that allows the user to read and edit the proposal on the terminal.

### Step 19:

The user reviews and edits the proposal on the terminal. The user reads each section, modifies text where necessary, adds comments or new content, and may request refinement of specific sections instead of the entire document. The input to this step is the displayed proposal text and controls. The output is modified content on the terminal, including edited text and user actions indicating which sections should be refined.

### Step 20:

The terminal sends modification information and refinement requests to the server. The terminal collects the changed text, identifies which sections have been edited, and bundles this information along with any explicit user commands such as “refine legal section” into a structured update message sent to the server. The input to this step is the modified proposal content and user commands. The output is a modification message containing section identifiers, edited text, and refinement instructions.

### Step 21:

The server updates stored proposal data based on modification information. The server compares the original stored sections with the edited text, updates the corresponding records in the database, and logs change history for each section. The input to this step is the modification message from the terminal. The output is an updated proposal record set in persistent storage and a change log associated with the case.

### Step 22:

The server adjusts prompt generation parameters based on user modifications and importance scores. The server analyzes patterns in the modifications, correlates them with the structured information and importance scores, and updates internal prompt templates or weighting rules. The input to this step is the modification log and the weighted structured information. The output is an updated configuration for prompt construction that influences how future prompt sentences emphasize or de-emphasize specific elements.

### Step 23:

The server generates a local prompt sentence for partial regeneration when requested. When the user requests refinement of a specific section, the server reads the existing section content, relevant structured information, and preference adjustments from Step 22, and composes a localized prompt that targets only that section. The input to this step is a refinement request, the associated section content, and context and preference data. The output is a local prompt sentence that instructs the generative AI model to regenerate or revise the targeted section while preserving key constraints.

### Step 24:

The server sends the local prompt sentence to the generative AI model and updates the section with the returned text. The server performs tokenization and parameter setting for the local prompt, transmits it to the model, receives the regenerated text, and replaces or merges the corresponding section in the stored proposal. The input to this step is the local prompt sentence and the current section state. The output is an updated section text that reflects the refined content generated by the model, stored and ready for redisplay to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In electronic document generation for project planning, conventional computer systems typically treat user input text as unstructured data and rely on simple keyword matching or rule-based templates to produce proposal documents. Such systems often require extensive manual configuration and expert intervention to define rules, select relevant regulatory requirements, identify technical issues, and assess market environment factors. As a result, the generated documents are frequently incomplete, inconsistent across projects, and poorly adapted to changes in applicable regulations, security risks, or market conditions. Furthermore, conventional systems generally do not transform natural language input into a structured representation that can systematically drive a generative AI model. Instead, they pass raw or minimally processed text to a model, which leads to unpredictable output quality, limited controllability of the generated content, and difficulty in ensuring that critical sections—such as legal concerns, security impacts, customer reactions, and risk reduction measures—are consistently and explicitly covered. This lack of structured, model-ready prompts prevents efficient reuse of analysis results and hinders scalable automation of proposal generation.

In addition, many existing systems fail to support iterative refinement of generated documents in a manner that is natively integrated into the underlying computational workflow. User feedback on a draft proposal is often handled outside the system (for example, by manual editing in a separate word processor), and the system does not use such feedback to adapt the prompt design or reconfigure the generative AI model in a structured way. Consequently, the computer system does not improve its subsequent outputs based on user interactions, and cannot efficiently converge to a high-quality, project-specific final proposal.

Moreover, prior systems that route information to organizational departments or set processing priorities generally rely on static routing tables or simple rules and do not exploit combined use of structured semantic analysis and generative AI models. These systems are therefore limited in their ability to map complex, multi-faceted project information to appropriate responsible departments, nor can they dynamically adjust prioritization of information based on inferred user emotion and domain-specific context. This leads to inefficient information handling, delayed responses, and suboptimal allocation of organizational resources.

Therefore, there is a need for a computer-implemented technique that improves the way a processor receives and analyzes natural language case information, converts that information into structured data, and constructs prompt sentences that effectively control a generative AI model. There is also a need for a system that integrates iterative, feedback-driven regeneration of project proposal documents, and that uses the same structured analysis and generative AI mechanisms to automatically allocate information to responsible departments and set processing priorities in a more adaptable and context-aware manner.

The specific processing by the specific processing unit 290 of the data processing device 12 in Application Example 1 is realized by the following means.

The present invention provides a server comprising a processor configured to receive, via an input/output device, case information in natural language from a user; to perform, by using a natural language processing technique, character string preprocessing, tokenization, sentence segmentation, and language identification on the received case information so as to convert the case information into analysis data; to extract, based on the analysis data, terms relating to regulatory requirements, technical issues, and market environment factors, and to classify the terms into at least one category including a regulation category, a technology category, and a market category so as to generate structured data; to organize, based on the structured data, an analysis result including a purpose of a case, the regulatory requirements, the technical issues, and the market environment factors, and to generate a prompt sentence for inputting the analysis result to a generative AI model; to operate the generative AI model by using the prompt sentence so as to generate a draft project proposal document based on the analysis result; to format the draft project proposal document into a document structure having at least one section including a case overview, legal concerns, security impacts, customer reactions, market environment, risk reduction measures, and advantages of the case; to store the draft project proposal document and the document structure in a storage device and transmit the draft project proposal document to a user terminal via the input/output device; to update the prompt sentence based on correction information or additional instructions for the draft project proposal document received from the user terminal, and to regenerate the project proposal document by using the generative AI model with the updated prompt sentence so as to iteratively revise the project proposal document and generate a final version; to generate, based on the structured data and the draft project proposal document including the legal concerns, the security impacts, and the customer reactions, a prompt sentence for automatically allocating information to responsible departments in an organization, and to determine the responsible departments by inputting the prompt sentence to the generative AI model; and to calculate an emotional state by applying an emotion analysis technique to input information from the user, to generate a prompt sentence for setting a priority of the information based on the calculated emotional state and the structured data, and to control, according to the priority, at least one of an allocation order of the information and a degree of emphasis in proposal content by inputting the prompt sentence to the generative AI model. This enables an improvement in computer technology by transforming unstructured natural language case information into structured, model-controlling prompt sentences that systematically guide a generative AI model, thereby enhancing the computer's ability to automatically generate, iteratively refine, and contextually route project proposal documents with consistent section coverage, adaptive departmental allocation, and priority control based on both domain-specific factors and inferred user emotion.

The term “case information” refers to information expressed in natural language by a user regarding a planned project, task, or matter to be analyzed, including at least a purpose, constraints, and contextual details.

The term “user” refers to a human operator or an entity that provides case information and feedback to the system via a user terminal.

The term “user terminal” refers to an electronic device operated by a user, including at least a computing device having an input unit, a display unit, and a communication unit for exchanging data with a server.

The term “server” refers to an information processing apparatus comprising at least one processor, a memory, and a communication interface, configured to execute programs for analyzing case information and generating documents.

The term “processor” refers to a hardware computing element, such as a central processing unit or an equivalent processing circuitry, configured to execute instructions to perform the functions described herein.

The term “input/output device” refers to a hardware and software interface that enables exchange of data between the processor and external devices, including at least a communication interface and, optionally, user interface components.

The term “natural language processing technique” refers to a computational method by which the processor analyzes human language text, including at least one of character string preprocessing, tokenization, sentence segmentation, language identification, part-of-speech tagging, and entity recognition.

The term “character string preprocessing” refers to processing that normalizes text, including at least one of converting character cases, removing extraneous symbols, harmonizing encodings, and standardizing spacing.

The term “tokenization” refers to processing that divides a text into smaller units, including at least words, symbols, or subword units, for subsequent analysis.

The term “sentence segmentation” refers to processing that divides a text into sentence-level units based on punctuation, syntax, or learned models.

The term “language identification” refers to processing that determines a natural language in which the case information is expressed.

The term “analysis data” refers to an internal representation generated from case information through natural language processing, including at least segmented sentences, tokens, and associated annotations used for further analysis.

The term “regulatory requirements” refers to obligations or constraints derived from laws, regulations, standards, or guidelines that are applicable to a project described by the case information.

The term “technical issues” refers to constraints, risks, or tasks related to hardware, software, network architectures, security mechanisms, or other technological aspects relevant to a project.

The term “market environment factors” refers to conditions or elements related to a commercial environment, including at least market trends, competitor presence, user segments, and adoption barriers.

The term “structured data” refers to data derived from analysis data in which extracted terms and related information are represented in a defined format with categories or fields, enabling deterministic processing by the processor.

The term “regulation category” refers to a logical grouping of terms or data elements that relate to regulatory requirements or compliance topics.

The term “technology category” refers to a logical grouping of terms or data elements that relate to technical issues, technologies, or technical constraints.

The term “market category” refers to a logical grouping of terms or data elements that relate to market environment factors, commercial context, or customer segments.

The term “analysis result” refers to an aggregated and organized representation of structured data that explicitly includes at least a case purpose, regulatory requirements, technical issues, and market environment factors.

The term “generative AI model” refers to a machine learning model configured to generate new data, including at least natural language text, in response to an input, and trained using large-scale example data.

The term “prompt sentence” refers to text or a structured message provided as input to a generative AI model, the text or structured message specifying instructions, context, and constraints for controlling a response generated by the generative AI model.

The term “draft project proposal document” refers to a computer-generated document produced by a generative AI model that provides an initial version of a project proposal based on an analysis result.

The term “document structure” refers to an arrangement of a document into sections or headings, each section representing a functional portion of content such as overview, legal concerns, or security impacts.

The term “case overview” refers to a section of a project proposal document that describes at least the purpose, scope, and main features of a case.

The term “legal concerns” refers to issues or risks related to laws, regulations, or compliance obligations that may affect a project.

The term “security impacts” refers to issues or risks related to protection of information, systems, or communications, including at least confidentiality, integrity, and availability considerations.

The term “customer reactions” refers to anticipated or observed responses, opinions, or evaluations of customers or users regarding a product, service, or project.

The term “market environment” refers to the competitive and commercial context in which a project is deployed, including at least market size, competition, and demand trends.

The term “risk reduction measures” refers to strategies, controls, or actions proposed to mitigate or lower the likelihood or impact of identified risks.

The term “advantages of the case” refers to strengths, benefits, or favorable characteristics of a project relative to alternatives.

The term “storage device” refers to a non-transitory computer-readable medium or memory device configured to store data, including at least analysis data, structured data, and documents.

The term “correction information” refers to modification data provided by a user, including at least edits, deletions, or additions to a draft project proposal document.

The term “additional instructions” refers to supplementary requirements or preferences specified by a user for revising or extending a draft project proposal document.

The term “final version” refers to a project proposal document that has been iteratively revised by the system based on user feedback and is designated for output as a completed document.

The term “predetermined document format” refers to a file or data representation format for documents, including at least one of a markup-based format, a page description format, or a word processing format.

The term “responsible departments” refers to organizational units or roles within an entity that are assigned responsibility for handling particular types of information or tasks.

The term “allocation of information” refers to an operation of assigning or routing information to one or more responsible departments based on content and context of the information.

The term “emotion analysis technique” refers to a computational method for inferring an emotional state from text or other input signals, including at least sentiment analysis or affective state classification.

The term “emotional state” refers to a representation of inferred user emotion, including at least positive, negative, neutral, or more detailed affective categories or scores.

The term “priority of the information” refers to an importance level or processing rank assigned to information, which influences ordering or emphasis in subsequent processing.

The term “allocation order of the information” refers to a sequence or schedule according to which information items are routed or processed by responsible departments.

The term “degree of emphasis in proposal content” refers to a relative amount of detail, prominence, or repetition assigned to particular topics within a generated project proposal document.

In one embodiment, a server executes a document generation program to implement the claimed system. The server includes at least one processor (for example, a general-purpose x86-64 central processing unit), a main memory, a non-transitory storage device, and a network interface. The server executes an operating system such as a server-class operating system, and application software implemented, for example, in a scripting language runtime or an application framework. The server may optionally include an accelerator, such as a graphics processing unit configured with a parallel computation library, to accelerate inference of a generative AI model.

The server executes a natural language processing module, a prompt generation module, a generative AI interface module, a document structuring module, a department allocation module, and a priority control module. These modules are implemented as software components stored in the storage device and loaded into main memory for execution by the processor. The modules operate upon data structures stored in the storage device, such as case information records, analysis data records, structured data records, prompt sentence records, and document records.

The terminal is a computing device such as a smartphone, tablet, or personal computer, including at least a processor, a memory, a display unit, an input unit, and a communication unit. The terminal executes a client application or a web browser application that presents a user interface to the user. The user operates the terminal to input case information and to review and revise generated project proposal documents. The terminal communicates with the server via a network using a communication protocol such as HTTPS.

The user operates the terminal to input case information in natural language. The terminal displays an input field implemented by a graphical user interface, and the user enters text describing a project, such as an electronic payment service or other service. The terminal transmits the case information as encoded character string data to the server. The server receives the case information and stores it in the storage device as a case information record, which includes at least a unique identifier, the original text, a timestamp, and user identification data.

The server applies a natural language processing technique to the case information to generate analysis data. In one embodiment, the server loads a natural language processing library, such as a statistical or neural-based text processing library, into memory. The server performs character string preprocessing by normalizing the text (for example, harmonizing Unicode representations, normalizing whitespace, and optionally performing case-folding).

The server then performs tokenization by dividing the text into tokens. The server may perform rule-based tokenization using deterministic rules (for example, splitting around whitespace and punctuation while preserving abbreviations), or may apply a trained segmentation model. The server further performs sentence segmentation by applying punctuation-based heuristics or a sequence labeling model that classifies token boundaries as sentence boundaries or non-boundaries. The server performs language identification by applying a classifier that uses character n-grams or word distributions as features, thereby determining which language model to apply in subsequent processing.

The server converts the output of these operations into analysis data represented as a data structure in memory. In one example, the analysis data is represented as an array of sentence objects, each sentence object containing an array of token objects. Each token object includes fields such as the original text, a normalized form, a token type, and optional annotations such as part-of-speech tags or named entity labels.

The server extracts regulatory requirements, technical issues, and market environment factors from the analysis data to generate structured data. In one embodiment, the server performs named entity recognition using a neural sequence labeling model, such as a bidirectional recurrent neural network or a transformer-based encoder that has been trained on annotated text to assign a label (for example, law, regulation, technology, product, organization, region) to each token span. The server also applies a keyword extraction algorithm, such as a term frequency-inverse document frequency scoring method or a graph-based ranking algorithm, to identify multi-word expressions that are salient in the case information. The server then applies classification rules and a learned classifier to map each extracted term to one of several categories: a regulation category, a technology category, or a market category.

The server stores the resulting structured data in a structured data record in the storage device. The structured data record may be represented as a set of fields, for example: a list of regulatory requirement entries, each including a term string, a confidence score, and optionally a reference identifier; a list of technical issue entries; and a list of market environment factor entries. This structured representation improves the server's ability to manage and reuse the analyzed content compared to conventional systems that operate solely on unstructured text.

The server organizes the structured data into an analysis result and generates a prompt sentence for a generative AI model. The server constructs an analysis result object that aggregates at least the case purpose, the regulatory requirements, the technical issues, and the market environment factors. The server may derive the case purpose by applying a text classification algorithm to identify intent sentences or summary sentences within the case information, and by selecting or generating a concise description field.

The server then generates a prompt sentence that encodes the analysis result in a form suited to a generative AI model. In one embodiment, the server maintains a prompt template including fixed instructional text and placeholders. The server fills the placeholders with the fields of the analysis result object. The prompt sentence is a natural language string that includes explicit instructions to the model regarding the required document sections and style.

For example, the server may generate a prompt sentence such as:
“You are an expert consultant in electronic payment services. Based on the following project description and extracted elements, draft a detailed project proposal.
Project description: ‘I want to develop a QR-code-based mobile payment app for small retailers in Japan.’
Laws and regulations: [Act on the Protection of Personal Information, anti-money laundering (AML) rules, know-your-customer (KYC) requirements].
Technical issues: [secure QR code generation, encryption of transaction data, user authentication, fraud detection].
Market environment: [strong competition from existing apps, small retailers seeking low-cost solutions].
Please include sections for: Project Overview, Legal Considerations, Security Impacts, Market Environment Analysis, Risk Mitigation Strategies, and Strengths and Opportunities.”

In another example embodiment, the server generates a prompt sentence for a more general mobile payment project:

“Analyze the laws, technical issues, and market environment that must be considered when developing a new mobile payment app in a particular jurisdiction, including data protection, KYC/AML, and security standards, and then draft a comprehensive project proposal that minimizes legal and security risks while maximizing the strengths of the project. Include sections for Project Overview, Legal Considerations, Security Impacts, Market Environment, Risk Reduction Measures, and Advantages of the Case.”

The server provides this prompt sentence to a generative AI model. In one embodiment, the generative AI model is implemented as a transformer-based neural network comprising multiple layers of self-attention and feedforward sublayers, trained on a large corpus of text using an autoregressive objective. The model is stored as parameter matrices in the storage device and is loaded into memory. The server configures the model with parameters such as the number of layers, the number of attention heads, the size of hidden representations, and a vocabulary embedding. The server executes a forward pass of the model by feeding tokenized prompt sentences to the encoder-decoder or decoder-only architecture, computing attention scores and applying nonlinear transformations, and finally producing probability distributions over output tokens at each step.

The server uses an inference algorithm, such as greedy decoding or beam search, to generate a sequence of tokens representing a draft project proposal document. The server may control sampling parameters such as temperature, top-k, or nucleus sampling thresholds. Unlike simple template-based or rule-based text generation, this generative process uses high-dimensional embeddings, multi-head attention, and learned contextual representations, enabling the model to combine the structured analysis result with broader domain knowledge encoded in its parameters. This leads to more consistent and contextually appropriate document content.

The server receives the generated token sequence, decodes it into text, and stores it as a draft project proposal document record. The server then applies the document structuring module. The server analyzes the generated text to identify section boundaries, for example by detecting section headings, applying pattern matching for predefined section names, or using a classifier that labels sentences with section types. The server restructures the document into a document structure representation, such as a tree or list where each node corresponds to a section (for example, case overview, legal concerns, security impacts, customer reactions, market environment, risk reduction measures, advantages of the case). Each section contains its own list of paragraphs.

The server stores the document structure in the storage device. The server transmits the draft project proposal document to the terminal. The terminal receives the document and displays each section as a separate content area. The user reviews the sections, edits content, or adds comments using an editing interface. The user may, for example, correct jurisdiction names, adjust risk descriptions, or request additional scenarios. The terminal transmits correction information and additional instructions back to the server.

The server updates the prompt sentence based on the user's feedback. The server incorporates the correction information by either directly modifying the structured data or by appending explicit instructions that refer to required changes. The server generates an updated prompt sentence that provides the generative AI model with both the prior draft and the user's requested changes. For example, the server may generate a prompt sentence such as:

“Here is the current draft project proposal and the user's comments. Revise the proposal to reflect the user's comments, add a dedicated section on customer reactions focusing on small retailers, and ensure that legal considerations for cross-border data transfers are explicitly described. Provide the full revised proposal as output.”

The server provides the updated prompt sentence to the generative AI model, runs another inference, and replaces or merges the generated text into the document structure. This iterative regeneration is not a mere automation of human editing; instead, the server uses the structured data and prompt design as control parameters that systematically steer the generative AI model to converge toward a consistent and complete final version. Because the server stores structured data and document structures, the server can apply targeted updates. For example, the server can request the model to regenerate only the legal concerns section based on updated regulatory requirements while preserving other sections unchanged. This selective regeneration reduces computational cost and network traffic compared to regenerating the entire document.

The server further uses the structured data and the draft proposal to perform automated allocation of information to responsible departments. The server generates a prompt sentence that summarizes the structured data and sections of the draft proposal and instructs the generative AI model to determine which organizational units should handle specific issues. The prompt sentence may include an explicit list of possible department categories (for example, legal, security, compliance, marketing, product development), along with criteria descriptions. The generative AI model outputs suggested mappings of issues to departments.

The server then converts these outputs into internal routing instructions stored as structured routing records. This process uses the same high-dimensional representation and attention mechanisms as the document generation, allowing the system to capture complex dependencies between issues and organizational responsibilities that are difficult to express in static rule sets.

The server also applies an emotion analysis technique to input information from the user. In one embodiment, the server uses a neural network classifier trained on labeled sentiment data. This classifier may be a smaller transformer or recurrent network that takes token embeddings as input and outputs a probability distribution over emotion labels or scores. The server represents the emotional state as a numeric vector that can be combined with structured data features. The server then generates a prompt sentence that instructs the generative AI model to assign higher priority or emphasis to items corresponding to more urgent or negative emotional states. For example, the server can instruct the generative AI model to emphasize certain risk items in the proposal when the user input expresses strong concern. By integrating emotion-derived features into prompt design, the system modifies the allocation order of information and the degree of emphasis in the proposal content in a way that conventional systems do not.

From a technical standpoint, the server's use of structured data and prompt sentences improves computational efficiency and output quality. By converting unstructured text into structured categories before invoking the generative AI model, the server reduces irrelevant context and focuses the model's attention on salient features. This reduces the average number of decoding steps needed to reach a high-quality proposal and lowers the variance of generated outputs. Further, by storing intermediate analysis results, the server avoids recomputing the natural language processing pipeline for each small user modification, thereby reducing processor load and network usage. The selective regeneration of sections minimizes inference time and energy consumption of the accelerator. Thus, the system improves processing speed and resource efficiency compared to naïve repeated full-document generation.

The server improves data management by representing case information, analysis data, structured data, prompt sentences, and document structures as distinct data types with defined relationships. This data model facilitates indexing, retrieval, and traceability of how specific terms influence final document content. For example, when a regulatory requirement changes, the server can identify all proposal documents and sections affected by that requirement and trigger targeted regeneration. This capability represents a technical improvement in document lifecycle management.

The server also improves accuracy and consistency. Because the analysis result explicitly lists regulatory requirements, technical issues, and market environment factors, the server can enforce coverage constraints. The server may apply a rule that if a particular category has entries, the corresponding section in the proposal must mention them. If the generated text omits a required item, the server can produce a supplemental prompt instructing the model to include missing items. This non-conventional use of an analysis-stage data structure to enforce coverage in the generation stage reduces omissions and logical gaps relative to purely generative systems.

In one training embodiment, the generative AI model is trained on pairs of structured data and target proposal documents. The server (or an offline training system) uses a loss function, such as cross-entropy between model outputs and reference tokens, combined with auxiliary losses that encourage accurate reproduction of structured terms in appropriate sections. The model parameters are updated by gradient-based optimization. The training process may use data augmentation techniques, such as paraphrasing or perturbing case descriptions while keeping structured data fixed, to make the model robust to diverse input phrasings. As a result, at inference time, the model more reliably respects the structured data provided through prompt sentences, which contributes to technical improvements in precision and recall of key content.

The server can adopt alternative implementations. In one variation, the natural language processing technique uses rule-based parsers and dictionaries for specific regulatory domains instead of or in combination with neural models. In another variation, the generative AI model runs on an external inference service accessed via a network interface, whereas the structured data generation and prompt construction remain on the local server; this reduces local computation at the cost of additional network latency. In a further embodiment, the system uses a smaller generative model to produce section outlines and a larger model to fill in detailed text, which can reduce computational cost while maintaining detail level.

The terminal may also vary. In one embodiment, the terminal is a mobile device with limited processing power, and most of the computation is performed on the server. In another embodiment, the terminal performs part of the natural language preprocessing locally, such as text normalization or language identification, and sends intermediate results to the server, thereby reducing the server's processing load. The user may select different output formats via the terminal, such as a markup-based format, a page description format, or a word processing format. The server converts the final version document structure into the selected format using format-specific rendering modules.

By structuring case information, using that structure to design prompt sentences, and iteratively regenerating documents under system control, the server improves how computational resources are used to generate, refine, and route complex proposal documents. This is not a mere automation of human drafting, but a specific improvement in computer operation: the server reduces redundant computations, constrains generative processes via structured inputs, enforces content coverage, and exploits emotion-derived features and department allocation logic to affect internal data flows and resource usage. These aspects collectively provide technical effects including improved processing speed, higher accuracy of generated content relative to domain constraints, better data management, reduced communication and inference overhead, and more effective control of complex neural models through structured prompt sentences.

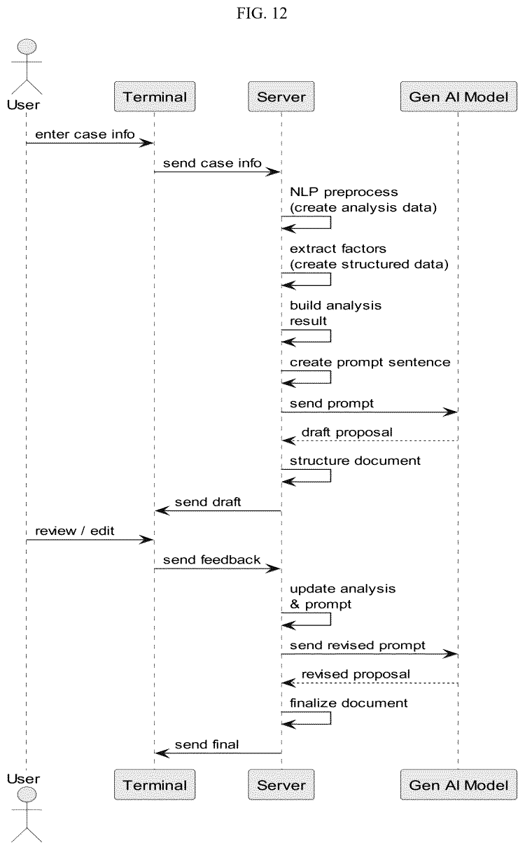

The following describes the processing flow using FIG. 12.

### Step 1:

The user operates the terminal to input case information in natural language.

The terminal displays an input screen including a text field and, optionally, selection fields for project type or jurisdiction.

Input: The user provides a natural language description of a case (for example, a new electronic payment project) via the keyboard or touch interface.

Processing: The terminal encodes the text as a character string, attaches metadata such as user ID and timestamp, and packages the data into a request object.

Output: The terminal outputs an encoded request containing the case information and metadata to be transmitted to the server over a network connection.

### Step 2:

The terminal transmits the encoded request to the server.

The terminal establishes an encrypted communication channel, for example using HTTPS, and sends the request to a predefined application endpoint on the server.

Input: The encoded request containing the case information and metadata.

Processing: The terminal applies network protocol processing, such as forming an HTTP message and performing necessary encryption and routing.

Output: The terminal outputs a network message that is delivered to the server's communication interface.

### Step 3:

The server receives the network message and stores the raw case information.

The server's communication module accepts the HTTP message, decodes the payload, and validates the structure of the request.

Input: The network message containing the encoded request with the case information and metadata.

Processing: The server parses the request, verifies required fields, assigns a unique case identifier, and writes the raw text and associated metadata into a storage device as a case information record.

Output: The server outputs a persistent case information record and a case identifier to be used by subsequent modules.

### Step 4:

The server generates analysis data by applying natural language preprocessing to the case information.

The server loads a natural language processing library into memory and executes functions for text normalization, tokenization, sentence segmentation, and language identification.

Input: The raw case information text from the case information record.

Processing: The server normalizes character encodings and whitespace, splits the text into tokens, identifies sentence boundaries, and classifies the overall language. These operations transform a single unstructured text string into a structured internal representation consisting of sentence objects and token objects with annotations.

Output: The server outputs analysis data comprising segmented sentences and annotated tokens stored in an analysis data record.

### Step 5:

The server extracts regulatory requirements, technical issues, and market environment factors from the analysis data to create structured data.

The server executes named entity recognition and keyword extraction algorithms using models loaded into memory.

Input: The analysis data including sentence and token-level annotations.

Processing: The server calculates feature vectors for each token span (such as embeddings or statistical features), applies a classifier to label spans as laws, technologies, products, regions, or other categories, and computes importance scores to select salient terms. The server then groups and maps the selected terms into category fields such as regulation category, technology category, and market category.

Output: The server outputs structured data, including lists of extracted terms and associated categories stored in a structured data record linked to the case identifier.

### Step 6:

The server constructs an analysis result by organizing the structured data and deriving a case purpose.

The server aggregates data fields and optionally identifies key sentences that express the project purpose.

Input: The structured data record and the original case information text.

Processing: The server applies a text classification or summarization method to determine the primary goal of the case, combines this goal with the categorized terms for regulatory requirements, technical issues, and market environment factors, and stores the results in an analysis result object.

Output: The server outputs an analysis result that explicitly contains a case purpose field and category-specific lists, stored as an analysis result record.

### Step 7:

The server generates a prompt sentence for a generative AI model based on the analysis result.

The server retrieves a template for prompt construction and fills the template with fields from the analysis result record.

Input: The analysis result record containing the case purpose and categorized elements.

Processing: The server formats a natural language instruction string that includes a description of the case, explicit lists of regulatory requirements, technical issues, and market environment factors, and a specification of required sections (such as project overview, legal concerns, security impacts, customer reactions, market environment, risk reduction measures, advantages of the case). This formatting operation maps structured fields into a linear text sequence with control phrases.

Output: The server outputs a prompt sentence, stored in a prompt sentence record and prepared for input to the generative AI model.

### Step 8:

The server invokes the generative AI model using the prompt sentence to generate a draft project proposal document.

The server loads a trained transformer-based generative AI model into memory, encodes the prompt sentence into token IDs, and performs inference.

Input: The prompt sentence from the prompt sentence record.

Processing: The server applies an embedding layer to convert tokens to vectors, processes these vectors through multiple attention and feedforward layers to compute contextual representations, and decodes output tokens using an autoregressive generation process (for example, greedy decoding or beam search). This computation uses learned weight matrices and nonlinear functions to produce a coherent text continuation forming a project proposal.

Output: The server outputs a generated token sequence decoded into a draft project proposal document text, stored as a draft document record.

### Step 9:

The server structures the draft project proposal document into defined sections.

The server analyzes the generated text to identify and label logical sections such as case overview, legal concerns, security impacts, customer reactions, market environment, risk reduction measures, and advantages of the case.

Input: The draft project proposal document text from the draft document record.

Processing: The server applies pattern recognition (for example, searching for headings or using a classifier to assign section labels to sentences), splits the text at identified boundaries, and organizes the resulting segments into a document structure data model where each section corresponds to a separate node with associated paragraphs.

Output: The server outputs a document structure representation linked to the draft project proposal document, stored as a document structure record.

### Step 10:

The server stores the draft project proposal document and the document structure and sends the draft to the terminal.

The server writes both the text and the structure into the storage device and prepares a response payload for the terminal.

Input: The draft document record and the document structure record.

Processing: The server packages the draft document content and section metadata into a data format suitable for transmission, such as a serialized structure or markup, and associates it with the case identifier.

Output: The server outputs a network response containing the draft project proposal document and its structure, which is transmitted to the terminal.

### Step 11:

The terminal receives and displays the draft project proposal document to the user.

The terminal decodes the received data and renders the content section by section on the display.

Input: The network response containing the draft project proposal document and the document structure.

Processing: The terminal parses the response, maps section identifiers to visual components (such as headings and text blocks), and updates the user interface so that the user can read and scroll through each section.

Output: The terminal outputs a visual presentation of the draft project proposal document and provides editable fields or comment areas associated with each section.

### Step 12:

The user reviews the draft project proposal document and provides correction information or additional instructions.

The user reads the displayed sections, identifies omissions or inaccuracies, and enters modifications or requests through the interface.

Input: The visualized draft project proposal document and editing controls on the terminal.

Processing: The user interacts with the interface to change text, insert comments, or specify additional constraints (for example, “add a section on customer reactions” or “emphasize cross-border data transfers”). The terminal captures these interactions as structured feedback data.

Output: The terminal outputs correction information and additional instructions in a feedback object to be sent to the server.

### Step 13:

The terminal transmits the correction information and additional instructions to the server.

The terminal encodes the feedback data and sends it over the established communication channel.

Input: The feedback object containing edited text, comments, and instructions.

Processing: The terminal forms a network request including the case identifier and the feedback fields, and applies the communication protocol to transmit the request to the server.

Output: The terminal outputs a feedback message delivered to the server's communication interface.

### Step 14:

The server integrates the correction information and additional instructions into the analysis and prompt generation process.

The server retrieves the corresponding analysis result, structured data, and document structure for the case and updates them based on the feedback.

Input: The feedback message containing correction information and additional instructions, along with existing records for the case.

Processing: The server applies text comparison and merge operations to reconcile user edits with existing document content, adjusts structured data fields if new regulatory requirements, technical issues, or market factors are identified, and records explicit revision instructions.

The server then generates an updated prompt sentence that encodes the user's feedback, referencing specific sections or issues to be revised.

Output: The server outputs an updated structured data record, an updated analysis result, and a revised prompt sentence record.

### Step 15:

The server regenerates the project proposal document using the generative AI model with the updated prompt sentence.

The server performs another round of model inference, optionally targeting specific sections for regeneration.

Input: The revised prompt sentence record and, optionally, the existing draft document structure.

Processing: The server encodes the updated prompt sentence into tokens, runs the generative AI model to produce revised sections or a full revised document, and integrates the new content into the existing document structure, replacing or appending sections according to revision instructions.

Output: The server outputs a regenerated draft or final project proposal document and an updated document structure record.

### Step 16:

The server determines responsible departments and information priorities using structured data and emotion analysis.

The server generates a prompt sentence for departmental allocation and applies an emotion analysis technique to user input to compute an emotional state.

Input: The structured data record, the draft or final project proposal document, and user input text used for emotion analysis.

Processing: The server feeds categorized terms and section summaries into a prompt sentence that describes department categories and allocation rules, and then uses the generative AI model to propose mappings of issues to responsible departments. In parallel, the server runs an emotion analysis classifier on user input, converts its output into a priority score vector, and generates an additional prompt sentence instructing the generative AI model or a rule engine to emphasize or route information according to the computed priority.

Output: The server outputs routing information linking items to responsible departments and priority levels, which can be stored as routing records and used to control further processing or highlighting within the proposal.

### Step 17:

The server finalizes and transmits the final version of the project proposal document to the terminal in a predetermined document format.

The server marks the latest version as final, converts the document structure into a selected format, and prepares it for delivery.

Input: The final project proposal document text and document structure record.

Processing: The server applies a formatting module to map sections and paragraphs into a word processing, page description, or markup format, embeds metadata such as creation time and version number, and compresses or packages the document if necessary.

Output: The server outputs a final version file or data stream in the predetermined document format and transmits it to the terminal, enabling the user to store, display, or distribute the completed project proposal.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented risk analysis and case management systems typically process case information in a rule-based or manually curated manner. In such systems, a server often receives unstructured text describing a project or case, and then a human operator or a static rule engine must interpret applicable regulations, security requirements, and expected customer reactions. This architecture suffers from multiple technical drawbacks.

First, the server generally lacks an efficient mechanism to automatically identify and retrieve only those law information items, security requirement information items, and reaction information items that are highly relevant to the received case information. Without an automated similarity-based filtering process operating on numerical representations, the server must either process large volumes of irrelevant reference information or rely on simplified keyword matching. This results in increased computational load, inefficient use of storage and network resources, and degraded responsiveness from the perspective of a user terminal.

Second, existing systems typically treat large language models or other generative models as a mere text-generation add-on, without structurally constraining their inputs and outputs. In particular, the server does not systematically construct a prompt sentence that encapsulates selected reference information and case information in a way that enforces a sectioned output format for legal concerns, security impacts, customer reactions, and improvement proposals. As a result, the output of a generative model is often unstructured, requiring additional manual processing or ad hoc parsing, which increases latency, consumes additional processor cycles, and may produce inconsistent or incomplete structured data for downstream computation.

Third, typical architectures do not integrate emotion analysis of user-related input information or response information into the core scheduling and routing mechanisms of the system. That is, even if emotion analysis is performed, it is not used by the processor to compute priority information and dynamically control the order of sorting or notification tasks within the server. This causes the system to handle urgent or emotionally critical cases in the same computational queue as low-priority cases, leading to suboptimal resource allocation, delayed responses for critical cases, and degraded perceived performance.

Fourth, many systems do not employ an embedding mechanism that converts both case information and reference information into numerical representations to compute similarity. Instead, they rely on direct text search, which does not scale well in terms of computational complexity and memory locality, particularly when the volume of reference data grows. This leads to inefficiencies in memory access patterns, cache utilization, and overall throughput of the server's processing pipeline when interacting with a generative AI model.

Accordingly, there is a need for a computer-implemented technique that improves the way a server prepares, filters, and structures information for a generative AI model, and that uses the model's outputs, together with structured risk indices and emotion-based prioritization, to optimize computational workflows. Such a technique should improve the efficiency of data processing, reduce the volume of irrelevant data sent to the generative AI model, provide structured outputs directly usable for automated risk calculation, and enable more effective scheduling and routing of cases across organizational divisions, thereby improving the functioning of the computer system itself.

The specific processing by the specific processing unit 290 of the data processing device 12 in Example 2 is realized by the following means.

The present invention provides a server comprising a processor and a memory storing instructions that, when executed by the processor, cause the server to receive, via an input/output device, case information including at least specification information of an article or a service, market information of a target domain, regulation information of a relevant norm, and past reaction information; to store the case information in a storage device and perform natural language processing on character information of the case information to extract important terms and a type of the relevant norm; to search an information storage device storing a set of law information, a set of security requirement information, and a set of reaction information based on the important terms and the type of the relevant norm and acquire a plurality of reference information items related to the case; to convert the case information and the reference information items into numerical representations, calculate relatedness between the case information and each reference information item based on the numerical representations, and select high-relatedness reference information items based on a threshold or ranking; to generate a prompt sentence including the selected reference information items and the case information so as to cause a generative information processing model to evaluate at least one of a legal concern, a security impact, and a customer reaction; to input the prompt sentence to the generative information processing model and acquire output information including an analysis result; to analyze the output information to generate, as structured data, a plurality of evaluation indices corresponding to a legal risk, a security risk, and a customer evaluation, and calculate a comprehensive risk evaluation value based on the evaluation indices; to generate report information including a plurality of items corresponding to the legal concern, the security impact, and the customer reaction and having a section structure including an improvement proposal; to output the report information to a display device or a recording device; to generate a prompt sentence for sorting the report information or the case information for each organizational division by determining, using the generative information processing model, a relevant organizational division from the analysis result; and to generate a prompt sentence for controlling an order of sorting processing or an order of notification by performing emotion analysis processing on user-related input information or response information, calculating priority information indicating a priority of the case or information based on a result of the emotion analysis processing, and using the priority information. This enables the server to improve internal data handling efficiency by numerically representing and filtering reference information prior to interaction with the generative information processing model, to obtain structured and sectioned analysis results directly usable for automated computation of risk indices, and to dynamically schedule sorting and notification tasks based on emotion-derived priority information, thereby enhancing processing throughput, reducing unnecessary data transfer and computation, and improving overall performance and responsiveness of the computer system.

The term “case information” refers to information describing a project, matter, or scenario to be analyzed, including at least specification information of an article or a service, market information of a target domain, regulation information of a relevant norm, and past reaction information related to such project, matter, or scenario.

The term “article or a service” refers to a product, functionality, offering, or provision of work, whether tangible or intangible, that is planned, developed, or provided in relation to the case information.

The term “target domain” refers to a market, region, industry, user segment, or application area in which the article or service is intended to be offered or used.

The term “regulation information” refers to information representing laws, rules, standards, policies, guidelines, or other normative requirements that may apply to the article or service or to the processing of related data.

The term “relevant norm” refers to a particular law, regulation, policy, standard, guideline, or rule identified as applicable or potentially applicable to the case information.

The term “past reaction information” refers to information indicating feedback, evaluations, opinions, complaints, or satisfaction levels from users, customers, or other stakeholders regarding articles, services, or cases similar to the case information.

The term “input/output device” refers to a hardware or software interface, such as a terminal device, a display unit, a keyboard, a pointing device, a network interface, or a graphical user interface, through which a user can provide case information to the server and receive output information from the server.

The term “storage device” refers to a memory element or data storage apparatus, such as a magnetic storage, optical storage, semiconductor memory, or database system, configured to store case information, reference information, report information, or other data used by the server.

The term “information storage device” refers to a storage device or database configured to store a set of law information, a set of security requirement information, and a set of reaction information for retrieval and analysis.

The term “law information” refers to data representing legal provisions, statutory texts, regulatory clauses, or other legal content that may be relevant to the case information.

The term “security requirement information” refers to information representing requirements, controls, rules, or best practices related to information security, including confidentiality, integrity, availability, access control, encryption, logging, and similar aspects.

The term “reaction information” refers to information representing feedback, comments, usage patterns, or evaluations from users or customers, including positive or negative reactions, that can be associated with particular articles, services, or cases.

The term “natural language processing” refers to computational processing of human language text, including at least one of tokenization, normalization, part-of-speech tagging, named entity recognition, syntactic analysis, or semantic analysis, performed to extract structured data or features from unstructured text.

The term “important terms” refers to words, phrases, or expressions extracted from the case information that are determined, based on natural language processing or rule-based criteria, to be significant for identifying relevant norms, laws, security requirements, or reaction information.

The term “type of the relevant norm” refers to a classification or category indicating which kind of regulation, standard, or policy (for example, privacy protection, consumer protection, data security, sector-specific regulation) is applicable or potentially applicable to the case information.

The term “reference information items” refers to individual records or data items retrieved from the set of law information, the set of security requirement information, and the set of reaction information, which are determined to be related to the case information.

The term “numerical representations” refers to vector representations, embeddings, or other numeric data structures obtained by converting textual or symbolic information into numerical form suitable for similarity computation or machine learning processing.

The term “relatedness” refers to a measure indicating a degree of relationship, similarity, or relevance between the case information and each reference information item, calculated based on their numerical representations.

The term “high-relatedness reference information items” refers to reference information items whose relatedness values with respect to the case information satisfy or exceed a predetermined threshold, or are ranked within a specified top range, and are therefore treated as highly relevant.

The term “threshold” refers to a predetermined numerical value used as a criterion to decide whether a relatedness or similarity value is sufficiently large to qualify a reference information item as highly relevant.

The term “ranking” refers to an ordered arrangement of reference information items based on their relatedness or similarity values relative to the case information.

The term “prompt sentence” refers to an input text, message, or instruction sequence constructed for providing to a generative information processing model, the input text including at least case information, selected reference information items, and directives specifying an analysis task or an output format.

The term “generative information processing model” refers to a computational model, such as a generative AI model or generative language model, configured to generate output information including natural language text or structured data in response to a provided prompt sentence.

The term “legal concern” refers to a potential issue, risk, or point of non-compliance associated with applicable laws, regulations, or policies related to the case information.

The term “security impact” refers to a potential effect, risk, or vulnerability related to information security, including unauthorized access, data leakage, data tampering, service disruption, or other security-related consequences associated with the case information.

The term “customer reaction” refers to an anticipated or observed response, such as satisfaction, dissatisfaction, trust, distrust, adoption, or rejection, from users or customers in relation to an article or service associated with the case information.

The term “output information” refers to information generated by the generative information processing model in response to the prompt sentence, including at least an analysis result relating to one or more of a legal concern, a security impact, and a customer reaction.

The term “analysis result” refers to content included in the output information that expresses the generative information processing model's evaluation, identification of issues, observations, or suggestions concerning legal concerns, security impacts, and customer reactions.

The term “evaluation indices” refers to structured indicators, scores, labels, or metrics that quantitatively or qualitatively represent levels of legal risk, security risk, and customer evaluation for the case information.

The term “legal risk” refers to a quantified or qualified likelihood and potential severity of non-compliance or adverse legal consequences arising from legal concerns identified in relation to the case information.

The term “security risk” refers to a quantified or qualified likelihood and potential severity of security incidents or vulnerabilities arising from security impacts identified in relation to the case information.

The term “customer evaluation” refers to a quantified or qualified representation of customer reaction, such as user satisfaction level, trust level, or likelihood of adoption, with respect to the article or service described in the case information.

The term “comprehensive risk evaluation value” refers to an aggregate measure or score that combines multiple evaluation indices, including at least legal risk, security risk, and customer evaluation, to represent an overall risk or suitability level for the case information.

The term “report information” refers to structured data or document content generated based on the analysis result and the comprehensive risk evaluation value, the structured data or document content including a plurality of items corresponding to the legal concern, the security impact, and the customer reaction, and optionally including improvement proposals.

The term “section structure” refers to an organizational format of report information that divides the content into distinct sections or parts, such as sections for legal concerns, security impacts, customer reactions, and improvement proposals.

The term “improvement proposal” refers to advice, recommendation, or countermeasure suggested to reduce legal risk, mitigate security risk, or improve customer evaluation associated with the case information.

The term “display device” refers to an apparatus configured to present information visually to a user, such as a monitor, screen, terminal display, or other visual output unit.

The term “recording device” refers to a device or mechanism configured to record or store information, such as a printer, external storage, or logging system, for later access by a user or another system.

The term “organizational division” refers to a functional group or unit within an organization, such as a legal division, security division, marketing division, or customer support division, which may be responsible for handling particular types of information.

The term “sorting” refers to processing for routing, classifying, or assigning report information or case information to one or more organizational divisions or processing queues.

The term “user-related input information” refers to information provided by a user, including text input, selection input, or interaction logs, which may express user intent, sentiment, or context.

The term “response information” refers to information output from the system to the user, or information received from the user in response to system output, which may contain indicators of user sentiment or urgency.

The term “emotion analysis processing” refers to computational processing for determining emotional states, such as satisfaction, frustration, urgency, or concern, from user-related input information or response information.

The term “priority information” refers to information representing a priority level or urgency level assigned to a case or piece of information, calculated based on a result of emotion analysis processing or other criteria.

The term “order of sorting processing” refers to the sequence in which multiple cases or pieces of information are processed or routed within the system based on their priority information or other scheduling criteria.

The term “order of notification” refers to the sequence or timing in which notifications or alerts concerning cases or information are transmitted to organizational divisions, devices, or users.

The term “structure designation information” refers to information included in a prompt sentence that specifies a desired structure, format, or section layout of an output generated by the generative information processing model.

The term “similarity” refers to a numerical value or metric indicating how closely the numerical representation of one information item, such as case information, resembles the numerical representation of another information item, such as a reference information item.

In one embodiment, a server implements the claimed system using one or more information processing devices. The server includes at least one multi-core central processing unit (CPU), such as a server-class general-purpose processor, a main memory such as a dynamic random access memory device, a non-volatile storage device such as a solid-state drive, and a network interface device connected to a communication network. The server executes an operating system such as a server-grade operating system and an application platform such as a web application framework or an application server. The server further cooperates with at least one terminal operated by a user. The terminal may be realized as a smartphone, tablet, notebook computer, or desktop computer including a display device, an input device, and a network interface. The terminal executes a client application or a web browser that provides a graphical user interface (GUI) for the user.

The server stores in the storage device a plurality of software modules implemented as executable instructions. These software modules include a communication module for handling requests from the terminal, a natural language processing module, an embedding module, a generative AI interface module, a similarity computation module, a report generation module, an emotion analysis module, and a routing and prioritization module. The server further stores a set of reference data including law information, security requirement information, and reaction information in one or more databases, which may be realized as a relational database system or a key-value storage system. The server also stores a trained generative AI model and, in some embodiments, a trained text embedding model as parameter files in the storage device.

The terminal displays on the display device an input screen for case information. The user uses the input device of the terminal to input a description of an article or a service, intended target domains or markets, applicable regulations known to the user, and any known customer feedback or past reaction information. The terminal structures the user input as a data object, such as a set of key-value pairs in a hierarchical structure, and transmits the structured case information via the network interface to the server using a secure communication protocol. By structuring the data on the terminal side, the amount of parsing processing at the server is reduced and the communication overhead is controlled.

The server stores the received case information in the storage device in association with a case identifier. The server uses the natural language processing module to tokenize the textual portions of the case information into word units and sentence units and to normalize the text by operations such as case-folding, punctuation handling, and language-specific normalization. The server may use a part-of-speech tagger and a named entity recognizer to identify important terms such as names of regulations, types of personal data, technical features, domain-specific terms, and geographical regions. For example, the server may identify “EU,” “health data,” “cross-border transfer,” and similar terms as important terms. Because the server performs this processing using an optimized natural language processing library, the server improves feature extraction accuracy and reduces noise compared to naive keyword matching.

The server uses the embedding module to convert the processed case information and each candidate reference record in the law information, security requirement information, and reaction information into numerical representations. In one embodiment, the embedding module uses a neural network-based sentence encoder. The neural network may be a Transformer-based architecture including multiple self-attention layers, feed-forward layers, and normalization layers. The embedding module receives tokenized text as input and outputs a fixed-dimensional vector as a numerical representation. The server stores these vectors in a vector database structure, either within a relational database using a vector extension or within a dedicated vector storage system.

The server uses the similarity computation module to calculate a similarity value between the case information vector and each reference information vector. The similarity may be calculated using cosine similarity, inner product, or another metric. The server uses the processor to perform these vector operations efficiently using optimized numerical libraries, thereby reducing the number of candidate reference items compared to full text scanning. Because the server discards reference information items whose similarity values are below a threshold or outside a top-ranked subset, the amount of data to be processed in downstream modules, particularly by the generative AI model, is significantly reduced. This reduction directly lowers memory usage, decreases cache misses, and reduces network bandwidth and latency when the generative AI model is provided via a separate inference server.

The server constructs a prompt sentence in natural language using the selected high-relatedness reference information items and the case information. The prompt sentence contains clear instructions not only to analyze legal concerns, security impacts, and customer reactions, but also to output the result in a structured, section-based format. The server includes, in the prompt sentence, structure designation information that specifies that output sections must include at least “Legal Risks,” “Security Impacts,” “Customer Reactions,” and “Recommended Actions.” Because the server precisely controls the structure and content of the prompt sentence, the generative AI model can produce consistent and machine-parseable output without additional complex post-processing, which improves throughput and reduces error rates in downstream parsing.

In one concrete example, the server constructs and uses the following prompt sentence for a case relating to a mobile fitness application:
“The user is planning to launch a subscription-based mobile fitness app that tracks step count, heart rate, and approximate location. The target markets are the EU and Japan. The app stores data in a cloud database and uses third-party analytics and push notification services. The app may share aggregated, anonymized statistics with partners.
Context—relevant regulations and security controls:
   Provisions on consent, data minimization, and cross-border data transfer under applicable privacy regulations.
   Provisions on personal data handling under applicable domestic privacy statutes.
   Internal security policy requiring up-to-date transport layer protection, strong encryption for data at rest, role-based access control, and centralized logging.
   Typical customer feedback for similar apps: concerns about continuous location tracking, data sharing with advertisers, and unclear privacy policies.
Task:
Analyze this case with respect to (1) legal concerns, (2) security impacts, and (3) expected customer reactions. Identify specific legal risks, possible security vulnerabilities or missing controls, and likely customer concerns or positive reactions. Then produce a structured report with the sections ‘Legal Risks,’ ‘Security Impacts,’ ‘Customer Reactions,’ and ‘Recommended Actions.’ Use concise bullet points and refer to specific types of regulations or controls when relevant.”

The server provides this prompt sentence to the generative AI model via the generative AI interface module. In one embodiment, the generative AI model is implemented as a large-scale Transformer-based language model comprising an embedding layer, multiple self-attention blocks, feed-forward blocks, and an output projection layer. The generative AI model is trained in advance on a large corpus of text using a gradient-based optimization method, such as stochastic gradient descent or an adaptive variant, by minimizing a loss function such as cross-entropy between predicted token distributions and actual tokens. During training, the model parameters are updated based on backpropagation of the loss, and data augmentation techniques such as random masking or noise injection may be employed to improve generalization. Because the model is trained to predict sequences conditioned on prompt sentences, the server can use the model to generate analysis text by performing only forward passes through the model given the constructed prompt sentence.

The server uses the processor to execute the generative AI interface module, which segments the prompt sentence into tokens, converts them into integer identifiers, and feeds them into the generative AI model. The model generates output token by token until end conditions are met. The server decodes the tokens back into characters and sentences, and obtains an output that contains at least the requested sections. This process exploits optimized linear algebra routines and parallel processing capabilities of the processor, improving processing speed compared to manual analysis or smaller rule-based engines.

The server uses the report generation module to parse the generated output. Because the server included explicit section names and instructions in the prompt sentence, the output naturally contains recognizable markers. The server splits the output into individual sections and transforms each bullet-point statement into structured records. The server then assigns numeric scores to qualitative risk levels. For example, the server may convert “high” risk labels to a score of 3, “medium” to 2, and “low” to 1. The server aggregates these scores across different dimensions using predefined weight coefficients stored in the storage device. By doing so, the server calculates a comprehensive risk evaluation value for the case. This computation is implemented as arithmetic operations and matrix operations, which the processor can execute efficiently, leading to reproducible risk evaluation with reduced human error.

The server further performs emotion analysis processing on user-related input information and response information. The emotion analysis module may implement a classifier based on a neural network model trained on labeled sentiment data. The neural network may be a recurrent neural network, a convolutional neural network, or a Transformer-based classifier that outputs probability scores for multiple emotion categories, such as “urgent,” “concerned,” or “neutral.” The server processes text messages, comments, or interaction logs from the user and determines an emotion label and a confidence score. Based on this score, the server derives priority information. By combining the priority information with the comprehensive risk evaluation value, the server adjusts the order of sorting or notification. For instance, when the server determines that a particular case has both a high comprehensive risk evaluation value and a high urgency emotion label, the routing and prioritization module moves the case to the front of internal processing queues or triggers immediate notification to specific organizational divisions. This mechanism improves responsiveness for critical cases and provides a technical effect of optimized scheduling and reduced average response time for high-risk, high-urgency cases.

The server uses the routing and prioritization module to determine organizational divisions to which the report information or case information should be routed. The server may construct an additional prompt sentence, including summary information of the case and the analysis result, and instruct the generative AI model to identify appropriate organizational divisions such as “legal,” “security,” “marketing,” or “support.” The prompt sentence may specify output in a structured form indicating relevant divisions. The server interprets the output and generates routing metadata. Because the server uses numerical representations, structured prompts, and controlled outputs, the system can automatically distribute cases to multiple divisions without manual routing logic, thereby simplifying system maintenance and improving routing accuracy.

The server outputs the generated report information to the terminal via the communication module. The terminal displays the report sections, risk scores, and recommended actions on the display device. The user can read the report and, if necessary, revise the case information and request a re-analysis. The terminal then reuses the same communication procedure with the server. This cyclic refinement mechanism allows the user to adjust system design or policies while the server repeatedly applies the described technical pipeline to updated data. The technical effect of the described embodiments arises from the specific combination of numerical representation-based filtering, structured prompt generation, generative AI model usage with constrained outputs, structured risk index computation, and emotion-based prioritization. The server does not merely automate human reasoning but modifies fundamental data handling and processing within the computer system. For example, by using vector embeddings and similarity thresholds, the server limits the amount of reference information passed to the generative AI model, resulting in reduced token counts, reduced network payloads to the model, and faster inference times. By enforcing section-based output via structure designation information in the prompt sentence, the server avoids complex, error-prone post-hoc parsing, which reduces processor cycles, memory allocations, and parsing errors. By combining emotion analysis-derived priority information with risk indices, the server improves internal scheduling of tasks, which is a core concern of computer systems and not merely a business rule.

Alternative embodiments may vary individual components while retaining the same technical principles. For example, the natural language processing module may employ different tokenization strategies or other language models. The embedding module may use alternative architectures such as recurrent networks or bag-of-words with dimensionality reduction. The similarity measure may be Euclidean distance or other kernel-based measures. The generative AI model may be deployed locally within the same server or on a separate inference server connected over a data center network. In some embodiments, multiple generative AI models specialized for different domains, such as privacy, security, or customer behavior, may be used in combination, and the server may select or ensemble results based on the type of the relevant norm. In other embodiments, the emotion analysis module may infer user emotion not only from text but also from interaction metrics such as response times, click patterns, or usage frequency, which are converted into feature vectors and processed by a classifier model.

In all such embodiments, the core configuration is that the server, rather than merely acting as a message relay, actively preprocesses, filters, and structures data before and after interactions with the generative AI model, using specific data structures such as numerical vector representations, similarity matrices, sectioned reports, and priority queues. This architecture brings measurable improvements in processing speed, memory usage, accuracy of risk identification, and responsiveness to critical cases, and thus improves the functioning of the computer system itself.

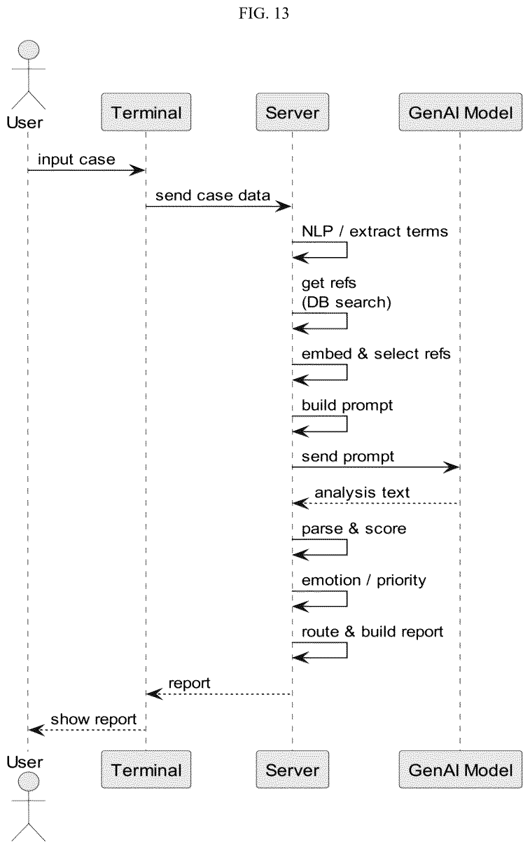

The following describes the processing flow using FIG. 13.

### Step 1:

The user operates the terminal to open a case input screen and enter case information.

The terminal receives, as input, raw user inputs including text describing an article or service, target markets, possibly applicable regulations, and known customer feedback.

The terminal converts these raw inputs into a structured internal data object, for example, a set of key-value pairs, by assigning each input field (such as “product_description,” “target_market,” “legal_context,” “security_context,” and “customer_feedback”) to a corresponding attribute.

The terminal performs local validation on the structured data, such as checking that required fields are not empty and that values such as dates and numbers have valid formats.

The terminal outputs a validated, structured case information object ready to be transmitted to the server.

### Step 2:

The terminal sends the structured case information to the server over a network.

The terminal receives, as input, the validated case information object created in Step 1.

The terminal serializes this object into a data stream, attaches metadata such as a tentative case identifier, user identifier, and timestamp, and encrypts the data using a secure communication protocol.

The terminal transmits the encrypted data to an application programming interface endpoint of the server.

The server receives this encrypted data stream, decrypts it using its communication module, and outputs a parsed, structured case information object into its internal memory.

### Step 3:

The server stores the received case information and prepares it for text processing.

The server receives, as input, the parsed case information object from Step 2.

The server writes the case information into a storage device, associating it with a persistent case identifier, and also loads the relevant text fields into main memory for analysis.

The server extracts textual fields such as product description, legal notes, and customer feedback, and outputs a set of raw text segments that will be passed to a natural language processing module.

### Step 4:

The server performs natural language processing on the extracted text segments.

The server receives, as input, the raw text segments from Step 3.

The server applies tokenization algorithms to split each segment into tokens (words and punctuation), executes normalization operations such as lowercasing and removal of certain non-informative symbols, and applies part-of-speech tagging and named entity recognition to identify important terms such as regulation names, data categories, and geographic regions.

The server aggregates the identified important terms and classification labels and outputs a processed text representation, including token lists, entity lists, and a set of important terms and candidate norm types.

### Step 5:

The server retrieves candidate reference information from internal databases based on important terms and norm types.

The server receives, as input, the processed text representation and the set of important terms from Step 4.

The server formulates database queries using these important terms and norm types to search one or more databases storing law information, security requirement information, and reaction information.

The server executes the queries and retrieves multiple reference records that may be related to the case, such as regulation excerpts, security control descriptions, and historical customer comments.

The server outputs a collection of candidate reference information items associated with the case identifier.

### Step 6:

The server converts text data of the case and reference information into numerical representations.

The server receives, as input, the case textual representation from Step 4 and the candidate reference information items from Step 5.

The server uses an embedding model, such as a Transformer-based sentence encoder, to encode each text segment into a fixed-length numerical vector. This includes mapping each token to an index, computing token embeddings, and processing the sequence through neural network layers to obtain sentence-level embeddings.

The server stores these vectors in memory or a vector-capable database and outputs numerical representations of the case information and each reference information item.

### Step 7:

The server computes similarity between the case and each reference item and selects high-relatedness references.

The server receives, as input, the numerical representations of the case information and reference information items from Step 6.

The server calculates similarity values, for example by computing cosine similarity between the case vector and each reference vector, and compares each similarity value with a predefined threshold or ranks all references by similarity.

The server discards reference items whose similarity is below the threshold or outside a specified top range and keeps only high-relatedness reference items.

The server outputs a reduced set of selected reference information items that are strongly related to the case.

### Step 8:

The server constructs a structured prompt sentence for a generative AI model.

The server receives, as input, the case information from Step 3 and the selected reference information items from Step 7.

The server concatenates a task description, constraints on the output structure, the case description, and summaries or excerpts of the selected reference items into a single natural language prompt sentence.

The server explicitly specifies, in the prompt sentence, that the generative AI model should analyze legal concerns, security impacts, and customer reactions, and that the output should contain separate sections labeled, for example, “Legal Risks,” “Security Impacts,” “Customer Reactions,” and “Recommended Actions.”

The server outputs the fully constructed prompt sentence as a text string ready to be input to the generative AI model.

### Step 9:

The server sends the prompt sentence to the generative AI model and obtains generated analysis text.

The server receives, as input, the prompt sentence from Step 8.

The server encodes the prompt sentence into tokens according to the vocabulary of the generative AI model, creates a sequence of token identifiers, and forwards this sequence to the generative AI model, which may be executed locally or on a connected inference server. The generative AI model processes the input sequence using its neural network parameters, computes probability distributions over next tokens at each generation step, and produces an output sequence of tokens representing an analysis that follows the requested structure.

The server decodes the output token sequence back into text and outputs generated analysis text containing at least sections for legal risks, security impacts, customer reactions, and recommended actions.

### Step 10:

The server parses the generated analysis and converts it into structured evaluation data.

The server receives, as input, the generated analysis text from Step 9.

The server scans the text for section headers and bullet markers corresponding to the specified output structure, splits the text into sections, and then divides each section into individual findings or recommendations.

The server applies mapping rules to translate qualitative terms such as “high risk,” “moderate risk,” or “low risk” into numeric scores for each of legal, security, and customer dimensions.

The server aggregates these numeric scores using predefined weight coefficients and arithmetic operations to compute evaluation indices and a comprehensive risk evaluation value for the case, and outputs a set of structured records representing these indices and the aggregated value.

### Step 11:

The server generates report information including structured sections and risk values.

The server receives, as input, the structured evaluation data and comprehensive risk evaluation value from Step 10, along with the original case information.

The server fills a report template by inserting the evaluation indices, risk scores, comprehensive risk value, and textual content of each section from the generated analysis into predefined positions, thereby creating a logically organized report with a section structure.

The server may compute summary indicators, such as an overall risk level icon or color code, based on the comprehensive risk value and embed these indicators into the report.

The server outputs report information in a structured document format, such as a markup format or a document object, suitable for rendering as a visual report or for conversion into a file format.

### Step 12:

The server performs emotion analysis on user-related information and calculates priority information.

The server receives, as input, user-related input information and response information, such as messages entered by the user, reaction comments, and interaction logs.

The server converts these inputs into feature representations, for example by tokenizing and embedding the text and by encoding interaction metrics, and processes the features with an emotion classification model that outputs probabilities for different emotional categories.

The server determines an emotion label and associated confidence value, then maps them to a numeric priority score using predefined rules or functions.

The server outputs priority information indicating a priority level for the case or related notifications, which can then influence scheduling and routing of processing tasks.

### Step 13:

The server determines routing targets and sorting order for organizational divisions.

The server receives, as input, the analysis result from Step 9, the structured evaluation data from Step 10, and the priority information from Step 12.

The server may construct a routing-specific prompt sentence summarizing key aspects of the case and requesting identification of relevant organizational divisions, and may obtain proposed divisions from the generative AI model, or may use rule-based mapping from risk categories to divisions.

The server combines the identified divisions with the priority score to create routing records that specify which division should receive the report information and in what order the notifications or tasks should be processed.

The server outputs a set of routing and scheduling instructions that assign the case and report information to processing queues or notification channels within the system.

### Step 14:

The server transmits the report information and routing results to the terminal and to relevant divisions.

The server receives, as input, the report information from Step 11 and the routing and scheduling instructions from Step 13.

The server formats a response to the terminal that includes the report content or a link to the report, and transmits this response via the communication module, while also sending notifications or messages to devices or systems associated with the designated organizational divisions according to the priority-based schedule.

The terminal receives the response, decodes the report information, and renders the report sections, risk indicators, and recommended actions on the display device for the user.

The terminal outputs a visual representation of the report and, optionally, status indicators showing which organizational divisions have been notified and in what priority order.

### Step 15:

The user reviews the report and optionally updates the case for re-analysis.

The user receives, as input, the displayed report on the terminal, including legal risk, security risk, customer reaction evaluations, and recommended actions.

The user inspects individual findings and, if necessary, edits case parameters such as processing methods, security controls, or target markets using input fields on the terminal.

The terminal collects the updated case information and prepares a revised structured data object, which can then be resubmitted to the server.

The server, upon receiving the revised information, treats it as new input and repeats some or all of the previous steps, thereby outputting updated analysis and report information that reflect the modifications made by the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information routing and ticketing systems in networked environments typically rely on static rules or simple keyword matching to assign incoming user information to organizational departments and to determine processing priority. In such systems, a processor generally parses user text, applies pre-defined routing rules, and sets a fixed priority level based on coarse-grained categories (for example, “billing,” “support,” or “legal”). This architecture presents several technical problems in terms of computer technology and automated information processing.

First, when legal regulations, security requirements, and user reaction patterns are complex and frequently updated, a static rule-based engine must be manually maintained and expanded. This leads to inefficient utilization of processor and memory resources, because the system either executes a large number of unused rules for each input or must perform repeated database lookups and conditional checks that are not tailored to the specific input context. As the volume and diversity of inputs increase, the rule set tends to grow non-linearly, thereby degrading system responsiveness and causing increased latency and processor load.

Second, known systems do not efficiently exploit generative artificial intelligence models as first-class computational components that receive carefully structured prompt sentences combining normalized user information, external legal and security context, preliminary rule-based evaluation results, and explicit user emotion information. Without such integrated prompt construction, the generative artificial intelligence model is either underutilized, receiving only raw text, or must internally re-derive context that the surrounding system already computed, leading to redundant computation and unnecessary network and processor overhead.

Third, conventional systems usually treat user emotion, if considered at all, as a simple sentiment score decoupled from core routing and prioritization logic. As a result, the processor does not systematically integrate emotion labels and emotion intensities with structured risk data when computing the processing priority or generating control information. This separation causes suboptimal ordering of tasks in the processing pipeline: for example, highly risky but emotionally urgent information may be processed in the same manner and sequence as low-risk or emotionally neutral information, resulting in inefficient use of computing resources for time-critical tasks and degraded user-perceived responsiveness.

Fourth, existing architectures lack a standardized, machine-structured way to translate the output of a generative artificial intelligence model into sorting information and control information that can be used by downstream components. Typically, the model output is consumed as unstructured natural language. This forces subsequent components to perform additional ad hoc parsing or to rely on human intermediaries, leading to increased processing time, higher memory consumption, and reduced determinism in the routing and prioritization pipeline.

Accordingly, there is a need for a computer-implemented system and method that technically improve the way a processor receives user information, merges that information with external regulatory and security context, performs preliminary rule-based evaluation, identifies user emotion, constructs and utilizes prompt sentences for a generative artificial intelligence model, and transforms the model's output into structured sorting information and control information. Such a system should allow the processor to dynamically determine both the target department or processing entity and the processing priority based on combined legal, security, customer-reaction, and emotion-aware indicators, thereby improving the efficiency, scalability, and responsiveness of the underlying computer system.

The specific processing by the specific processing unit 290 of the data processing device 12 in Application Example 2 is realized by the following means.

The present invention provides a server comprising a processor configured to receive, via an information input/output interface, information from a user including transaction information or case information, to normalize the received information and acquire, from a storage device or an external information source, regulation information, security requirement information, and user reaction information related to the received information and to integrate the acquired information as reference context, to perform preliminary evaluation processing in accordance with a rule set based on the received information and the reference context and to calculate at least one evaluation indicator related to legal concern, security impact, and customer reaction, to identify an emotional state of the user by using emotion analysis technology based on the information from the user and additional information to be analyzed and to generate emotion information including an emotion label and an emotion intensity, to generate a prompt sentence including the information from the user, the reference context, a result of the preliminary evaluation processing, and the emotion information and to provide the prompt sentence as input to a generative artificial intelligence model, to input the prompt sentence into the generative artificial intelligence model and execute inference processing to cause the generative artificial intelligence model to generate output information including an evaluation result related to the legal concern, the security impact, and the customer reaction and including an improvement proposal, to analyze the output information obtained from the generative artificial intelligence model, extract structured data representing at least a legal risk level, a security risk level, a customer satisfaction prediction, and the improvement proposal, and generate sorting information for specifying a department or processing entity that is a target to which the information is to be allocated, to generate priority information including an explanation sentence adapted to the emotional state of the user and a processing priority of the information based on the emotion information and the structured data and to generate control information for ordering processing of the information in accordance with the priority information, and to output a prompt sentence or a control command including the sorting information and the priority information, the prompt sentence or the control command being for allocating the information to an appropriate department or processing entity and for setting the processing priority of the information. This enables the underlying computer system to more efficiently utilize processor and memory resources by offloading context-aware analysis to the generative artificial intelligence model via structured prompt sentences, to reduce redundant computation by integrating preliminary rule-based evaluation and emotion analysis prior to model invocation, to dynamically control routing and prioritization based on combined legal, security, customer-reaction, and emotion-aware indicators encoded as structured control information, and thereby to improve responsiveness, scalability, and technical performance of automated information processing in networked environments.

The term “information input/output interface” refers to a hardware or software interface that enables a processor to receive information from a user and to output information toward the user or external components, including, for example, network interfaces, display interfaces, and input device interfaces.

The term “transaction information” refers to data that specifies details of an electronic transaction, including, for example, item information, pricing information, counterparty information, payment information, and contextual parameters related to a commercial or service transaction.

The term “case information” refers to data that specifies details of a planned or ongoing activity or project, including, for example, objectives, scope, schedule, participants, and constraints of the activity or project.

The term “regulation information” refers to data representing rules, laws, standards, guidelines, or policies applicable to a transaction or case, including, for example, statutory provisions, regulatory requirements, and internal compliance rules.

The term “security requirement information” refers to data representing conditions, constraints, or standards for maintaining confidentiality, integrity, and availability of information or systems, including, for example, authentication requirements, encryption policies, and access control rules.

The term “user reaction information” refers to data that indicates responses of users to products, services, transactions, or cases, including, for example, feedback, ratings, comments, complaints, and satisfaction scores.

The term “reference context” refers to a collection of data derived from regulation information, security requirement information, user reaction information, or related data sources that is associated with received user information and used as contextual input in analysis and evaluation processes.

The term “preliminary evaluation processing” refers to rule-based processing executed prior to invocation of a generative artificial intelligence model, in which the processor applies a rule set to received information and reference context to compute one or more evaluation indicators related to legal concern, security impact, or customer reaction.

The term “rule set” refers to a collection of machine-executable rules or conditions that define logical relationships between input data elements and evaluation results, including, for example, if-then rules for identifying potential legal or security issues.

The term “evaluation indicator” refers to a quantified or categorized measure computed from input data, representing a degree of legal concern, a level of security impact, a degree of customer reaction, or a similar evaluative metric.

The term “legal concern” refers to a potential or actual issue related to compliance with laws, regulations, or policies, including, for example, risk of violation of statutory provisions or regulatory requirements.

The term “security impact” refers to a potential or actual effect on information security or system security, including, for example, increased risk of unauthorized access, data leakage, or service disruption.

The term “customer reaction” refers to a response of a user or customer to a product, service, transaction, or case, including, for example, perceived satisfaction, dissatisfaction, trust, or distrust.

The term “emotion analysis technology” refers to a computational technique that analyzes input data such as text, audio, or image data to identify an emotional state of a user, including, for example, techniques based on machine learning, pattern recognition, or natural language processing.

The term “emotional state” refers to a psychological condition of a user such as anxiety, anger, satisfaction, happiness, sadness, or neutrality, as inferred from user-provided data.

The term “emotion information” refers to data representing an identified emotional state of a user, including at least one emotion label and optionally an emotion intensity or confidence value.

The term “emotion label” refers to a categorical representation of an emotional state, such as “anxious,” “angry,” “satisfied,” “happy,” or “neutral,” that is associated with user data.

The term “emotion intensity” refers to a quantitative or ordinal value indicating a strength or degree of an emotional state, such as a probability, score, or level associated with an emotion label.

The term “prompt sentence” refers to a text sequence or document provided as input to a generative artificial intelligence model, the text sequence or document specifying context, instructions, or questions that guide the model in generating output information.

The term “generative artificial intelligence model” refers to a computational model, implemented in hardware or software, that is configured to generate output data such as text or structured data in response to input data, using learned parameters obtained from training on data sets.

The term “inference processing” refers to processing performed by a generative artificial intelligence model in which the model receives input data such as a prompt sentence and generates output data based on internal model parameters without changing the parameters.

The term “output information” refers to data generated by a generative artificial intelligence model in response to a prompt sentence, including, for example, evaluation results, explanations, improvement proposals, and structured or unstructured text.

The term “improvement proposal” refers to a recommended action or set of actions generated by the system or the generative artificial intelligence model for reducing risk, resolving an issue, or enhancing performance or user satisfaction in relation to a transaction or case.

The term “structured data” refers to data organized in a predetermined format or schema, such as key-value pairs, tables, or records, that represent attributes including at least a legal risk level, a security risk level, a customer satisfaction prediction, or an improvement proposal.

The term “legal risk level” refers to a value or category representing a degree of legal risk associated with a transaction or case, including, for example, levels such as low, medium, or high.

The term “security risk level” refers to a value or category representing a degree of security risk associated with a transaction or case, including, for example, levels such as low, medium, or high.

The term “customer satisfaction prediction” refers to an estimated value or category indicating a likelihood that a user or customer will be satisfied with a product, service, transaction, or case, based on historical data or model inference.

The term “sorting information” refers to data specifying a department, group, processing entity, or processing path to which information is to be allocated, based on evaluation results or model output.

The term “department” refers to an organizational unit or functional group within an entity, such as a legal group, security group, customer support group, or operations group, that is responsible for handling specific categories of information.

The term “processing entity” refers to a logical or physical component, including a department, a software module, or a hardware resource, that is configured to process a particular type of information.

The term “priority information” refers to data indicating a processing priority of information, including, for example, ranking, ordering, or urgency level, and optionally including an explanation sentence adapted to the user's emotional state.

The term “processing priority” refers to a relative level or order in which a system processes multiple pieces of information, such as high, medium, or low priority, or a numerical priority ranking.

The term “control information” refers to data used by the system to control ordering, allocation, or scheduling of information processing, including, for example, commands, flags, or parameters indicating sorting order or execution sequence.

The term “control command” refers to a machine-readable instruction that directs a component of the system to perform a particular processing operation, such as assigning information to a department, changing a priority, or updating a processing queue.

The term “explanation sentence” refers to a natural language text generated or selected by the system that explains an evaluation result, risk level, or recommendation, and that may be adapted in tone or content to the user's emotional state.

Server executes the claimed invention as software running on general-purpose computer hardware configured with specialized data structures and machine-learning components. Terminal operates as an input/output device for the user and as a pre-processing and post-processing node. User interacts with the terminal to supply information and to view and act on results.

Server includes at least one processor, a main memory, and a storage device such as a magnetic disk or solid-state drive, coupled via a system bus. Server also includes a network interface to communicate with multiple terminals over a packet-switched network. In one embodiment, server is implemented on a multi-core processor architecture with hardware acceleration for vector and matrix operations, such as a graphics processing unit. Server runs an operating system such as a general-purpose server operating system and executes application programs implemented, for example, in a programming language such as a high-level scripting language or a compiled language.

Terminal includes a processor, a memory, a display device, and input devices such as a keyboard, a pointing device, and a microphone. Terminal may be implemented as a mobile communication device, a portable computer, or a stationary workstation. Terminal executes a client program, such as a web-browser-based application or a native application, configured to transmit user information to server and to render server responses on the display.

User operates terminal to input information including transaction information or case information. User enters text via a text input field, and optionally provides voice input via the microphone. Terminal converts the voice input to text using a speech recognition library executed locally or using an external speech recognition service. Terminal then packages the text information into a structured data object, for example a hierarchical key-value structure, including fields such as “case_description”, “transaction_metadata”, and “user_statement”. Server receives the structured data object from terminal via an application programming interface exposed over a secure network connection. Server stores the raw data object in storage for traceability, and then decomposes the object into normalized internal representations. For example, server converts character encoding to a unified format, segments the text into sentences, tokenizes the text into word or subword units, and maps categorical fields such as jurisdiction or product type to internal numeric identifiers.

Server further enriches the normalized information by acquiring reference context from a regulation database, a security policy database, and a user reaction database. Server accesses these databases using structured query language queries and retrieves regulation information records, security requirement records, and user reaction records that match the jurisdiction code, product category code, and transaction type code derived from the user input. Server aggregates the retrieved records into an internal reference context structure, for example a composite object that holds lists of law articles, security rules, and historical feedback summaries.

Server performs preliminary evaluation processing using a rule set stored in storage. The rule set is encoded as a table of conditions and corresponding actions, where conditions reference fields of the normalized user information and fields of the reference context. Server loads the rule set into memory and iterates over the rules. For each rule, server evaluates predicates such as comparisons, membership tests, and logical combinations. When a predicate is satisfied, server updates one or more evaluation indicators. For example, server increments a legal risk score if the information indicates cross-border transfer of personal data without consent, or server elevates a security risk level if the transaction amount exceeds a predefined threshold while originating from an untrusted network.

Server calculates evaluation indicators as numeric or categorical values representing degrees of legal concern, security impact, and customer reaction. Server stores these evaluation indicators in association with the case or transaction identifier in storage. This pre-processing step reduces the amount of work that the generative AI model must perform, because server performs deterministic screening based on structured rules.

Server analyzes user emotion using emotion analysis technology. In one embodiment, server employs a neural-network-based text classifier operating on the user statement. Server first converts the user statement into token indices using a tokenizer consistent with the model's vocabulary. Server then passes the token indices through an embedding layer, a sequence encoder such as a bidirectional recurrent neural network or a transformer encoder, and a classification head. The classification head outputs a probability distribution over emotion categories such as anxiety, anger, satisfaction, and neutrality. Server selects the highest-probability category as an emotion label and uses the probability as an emotion intensity value. In another embodiment, server additionally processes voice features such as pitch, energy, and spectral coefficients using a convolutional or recurrent neural network trained for emotion recognition. Server combines text-based and audio-based predictions through a weighted average or a learned fusion layer to obtain a final emotion information record.

Server generates a prompt sentence for a generative AI model using the normalized user information, the reference context, the preliminary evaluation indicators, and the emotion information. Server constructs the prompt sentence as a concatenation of multiple segments, each labeled with a marker such as “User description:”, “Legal and security context:”, “Preliminary evaluation:”, and “Detected user emotion:”. Server also appends an instruction segment that describes tasks to be performed by the generative AI model, including evaluation of legal concerns and security impacts, prediction of customer satisfaction, and generation of improvement proposals. By organizing the prompt sentence with explicit sections and markers, server reduces ambiguity and ensures that the generative AI model can more efficiently map input tokens to internal representations.

Server, for example, generates a prompt sentence as follows:
“User description: ‘We want to launch an online subscription service in the EU that collects user browsing data for personalization.’
Legal and security context: The jurisdiction is the European region. Data protection regulations apply. Data are stored on remote servers in another jurisdiction. Security requirements include strong authentication, encryption in transit and at rest, and access logging.
Preliminary evaluation: A data protection compliance check is required. Cross-border data transfer risk is medium. Some customer feedback on similar services indicates concerns about privacy but overall high satisfaction when transparency is improved.
Detected user emotion: The user is ‘anxious’ with confidence 0.82. The user said: ‘I am worried about the legal risks of this project.’
Task: As a generative AI model, evaluate whether this project may violate any applicable data protection laws or security requirements, indicate specific legal and security risks with their relative levels, estimate likely customer satisfaction based on the context, and propose concrete actions to reduce legal and security risks and to reassure an anxious user. Use clear and calm language in your explanation.”

Server supplies the prompt sentence to the generative AI model executing either on server hardware or on a remote computation node. In one implementation, the generative AI model comprises a transformer-based neural network with multiple attention layers, feedforward layers, and normalization layers, trained on large-scale text data. The model receives the prompt sentence as a sequence of token embeddings and computes output probabilities over vocabulary tokens for each position using self-attention mechanisms. During inference, server performs autoregressive generation, at each step feeding back the previously generated tokens and computing the next token distribution with the model's parameters fixed. Server may apply decoding strategies such as beam search or nucleus sampling to balance determinism and diversity.

Server configures the generative AI model with specific parameters such as maximum length and decoding temperature to control computational load and quality. Because server has already performed rule-based preliminary evaluation and emotion recognition, the prompt sentence is highly structured and targeted. This reduces the number of tokens necessary to convey context, thereby decreasing computation time and memory consumption during inference. The combination of structured prompt construction and pre-filtered context also improves the consistency and relevance of model outputs, which reduces the need for post-processing and re-invocation.

Server receives output information from the generative AI model as a text sequence that includes evaluation results and improvement proposals. In one embodiment, server instructs the model in the instruction segment to output results in a semi-structured form, for example with labels such as “Legal risk level:”, “Security risk level:”, “Customer satisfaction prediction:”, and “Improvement proposals:”. Server parses the output by scanning for such labels and extracting the corresponding values. In another embodiment, server prompts the generative AI model to output a key-value-like text format, which server parses using simple string and pattern matching functions rather than more expensive natural-language understanding components.

Server transforms the parsed output into structured data objects. For example, server converts risk level descriptors such as “low”, “medium”, and “high” into enumerated codes, and stores lists of improvement proposals as arrays of records, each record including a textual description and a category such as legal, security, or customer experience. Server then generates sorting information by mapping combinations of risk levels and proposal categories to organizational entities or processing components. For instance, server may determine that information with a high legal risk level and a data protection-related issue should be allocated to a compliance group, while information with a high security risk level and network-related issues should be allocated to a security operations group.

Server also generates priority information by combining emotion information and risk levels. If the emotion label indicates high anxiety or anger (interpreted from high probability or intensity), and the legal or security risk level is medium to high, server raises the processing priority value for the corresponding information. Conversely, if the emotion label indicates satisfaction and the risk levels are low, server lowers the processing priority. Server stores the priority information as part of a control information structure, which further includes identifiers of target processing queues and scheduling parameters.

Server outputs prompt sentences or control commands including sorting information and priority information to downstream processing modules. For example, server may send a command to a workflow management system specifying that a particular case should be placed into a high-priority queue for the compliance group. Server may also generate a user-facing explanation sentence that reflects both risk assessment and emotion, such as:

“Your project involves medium legal and security risks related to data protection, but these risks can be managed by implementing clear consent mechanisms, limiting data retention, and applying strong encryption. The following steps will help you reduce risk and should make you feel more confident about proceeding.”

Terminal receives such explanation sentences and displays them on the user interface, optionally highlighting key recommendations. Because the explanation is generated based on structured data and emotion-aware processing, terminal can present information in a way that increases user understanding while leveraging the underlying technical improvements in risk computation and routing.

Server, by integrating rule-based evaluation, emotion recognition, structured prompt sentence generation, and generative AI model inference, achieves technical effects beyond simple automation of human tasks. The preliminary evaluation reduces the dimensionality and variability of inputs passed to the generative AI model, resulting in decreased computation time and lower memory usage per inference. The structured prompt sentence and labeled segments improve the mapping between input tokens and internal attention patterns in the model, thereby improving prediction accuracy and reducing the number of re-tries. The explicit transformation of free-form model output into structured data and control information enables deterministic, low-overhead routing and scheduling decisions inside server, reducing the need for additional natural language parsing.

Server also improves data management by maintaining normalized representations and structured risk indicators that can be aggregated and queried efficiently. For example, server can compute statistics of legal risk levels across many cases using database aggregation functions without re-running the generative AI model. This separation of deterministic features and generative features reduces redundant inference and spreads computational load more evenly.

In one alternative embodiment, server trains the generative AI model and emotion analysis model using supervised learning on labeled datasets stored in storage. Server partitions the datasets into training and validation sets, initializes model parameters, and performs iterative optimization using a gradient-based method such as stochastic gradient descent with momentum or adaptive methods. Server defines a loss function that combines cross-entropy loss for classification tasks and auxiliary losses for sequence generation quality. Server updates the model weights based on gradients computed by backpropagation and saves trained parameters to storage. This training process enables server to tailor the model to domain-specific legal, security, and customer-reaction data, which improves accuracy and reduces inference errors.

In another variant, server employs a hierarchical data structure for the rule set, such as a decision-tree-like representation, and organizes rules in a tiered manner according to jurisdiction and transaction type. When processing a new case, server first selects only relevant branches of the rule set based on jurisdiction code and transaction code, and then evaluates rules within that branch. This design reduces the number of rule evaluations per input, thereby decreasing processor cycles and latency.

In yet another embodiment, terminal performs a subset of emotion analysis locally using a compact classification model optimized for the device. Terminal extracts simple features and computes a preliminary emotion label, which is then refined by server using more complex models. This distribution of computation between terminal and server reduces communication bandwidth and server load, while still allowing server to maintain high accuracy through more sophisticated models.

User benefits from the invention when using the system for managing complex cases or transactions that involve legal and security considerations. User can input natural language descriptions without manually selecting departments or priority levels, because server computes routing and priority based on structured analysis. The combined pipeline of deterministic rules, emotion-aware processing, and generative AI inference results in more accurate and faster routing decisions than relying solely on manual classification or keyword-based systems. The technical improvements are realized within the computer system: reduced processing time through hierarchical rules and targeted prompts, improved memory efficiency through context selection, enhanced accuracy through fused emotion and risk indicators, and reduced communication overhead through structured data representations instead of unstructured text exchanges.

Accordingly, the invention is not limited to a particular business scenario but provides a specific improvement in computer technology: a coordinated architecture for pre-processing, prompt sentence construction, generative AI model interaction, and post-processing that transforms incoming user information into structured control signals that more efficiently drive internal computational resources and external processing entities.

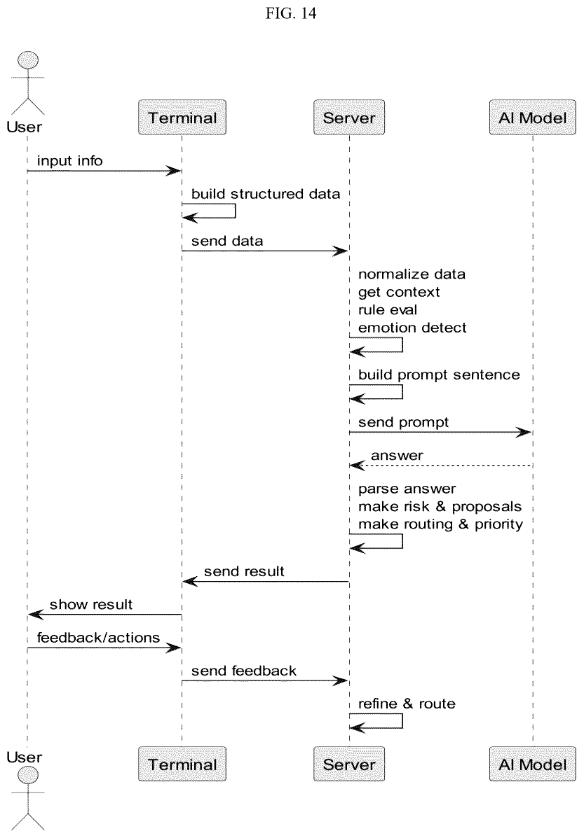

The following describes the processing flow using FIG. 14.

### Step 1:

User operates the terminal to input information.

User enters text describing a transaction or a case (for example, “We want to launch a new subscription service in the EU” or “This payment feels risky to me”) via a text field, and optionally records voice input via a microphone.

Input: raw user text, optional raw audio.

Output: user text data and audio data captured on the terminal.

### Step 2:

Terminal converts raw input into a structured data object.

Terminal uses a speech recognition function to convert the audio data into text, merges it with the typed text, and constructs a structured object (for example, a key-value structure) that includes fields such as “case_description”, “transaction_information”, “user_statement”, “jurisdiction”, and “device_metadata”.

Input: user text data, audio data.

Processing: audio-to-text conversion, concatenation of text, assignment into structured fields.

Output: structured user information object.

### Step 3:

Terminal transmits the structured user information to the server.

Terminal serializes the structured user information into a payload and sends the payload to the server over a secure network connection using a network protocol.

Input: structured user information object.

Processing: serialization, encryption or secure transport preparation, network transmission.

Output: network message containing the structured user information received by the server.

### Step 4:

Server normalizes the received user information.

Server parses the payload, decodes character encoding, segments text into sentences, and tokenizes the text into word or subword units. Server maps categorical items such as jurisdiction and product type to internal numeric codes using lookup tables.

Input: structured user information object from the terminal.

Processing: parsing, text normalization, tokenization, category-to-code mapping.

Output: normalized user information record with internal codes and tokenized text.

### Step 5:

Server acquires reference context from internal and external data sources.

Server uses the jurisdiction code, product code, and transaction type code contained in the normalized user information to query regulation records, security requirement records, and user reaction records from one or more databases or external services.

Input: normalized user information record (including jurisdiction code, product code, transaction type code).

Processing: database queries, external API calls, aggregation of retrieved records into unified structures.

Output: reference context object including regulation information, security requirement information, and user reaction information.

### Step 6:

Server performs preliminary rule-based evaluation.

Server loads a rule set that specifies conditions linking fields of the normalized user information and fields of the reference context to evaluation indicators. Server iterates over the rules, evaluates logical predicates, and updates evaluation indicators such as legal risk score, security risk level, and customer reaction score whenever a predicate is satisfied.

Input: normalized user information record, reference context object, rule set.

Processing: conditional evaluation, numeric score updates, category assignment.

Output: preliminary evaluation result including evaluation indicators for legal concern, security impact, and customer reaction.

### Step 7:

Server analyzes the user's emotional state.

Server processes the user statement text (and optionally voice features) using an emotion analysis model. Server converts the text into token indices, passes them through an embedding layer and sequence encoder, and applies a classification head to obtain probabilities over emotion categories. Server selects the emotion label with the highest probability and uses the probability as the emotion intensity.

Input: user statement text (and optionally audio features).

Processing: tokenization, embedding lookup, neural network inference, probability computation, label selection.

Output: emotion information including at least an emotion label and an emotion intensity.

### Step 8:

Server constructs a prompt sentence for the generative AI model.

Server composes a single prompt sentence (or document) that concatenates segments for the user description, legal and security context, preliminary evaluation summary, and detected user emotion. Server appends an instruction segment specifying that the generative AI model should evaluate legal risks, evaluate security impacts, predict customer satisfaction, and generate improvement proposals adapted to the user's emotional state.

Input: normalized user information record, reference context object, preliminary evaluation result, emotion information.

Processing: text generation for each segment, concatenation into a single text, insertion of markers such as “User description:” and “Task:”.

Output: prompt sentence text for the generative AI model.

### Step 9:

Server invokes the generative AI model with the prompt sentence.

Server tokenizes the prompt sentence using a tokenizer consistent with the generative AI model, converts tokens into embeddings, and sends the token sequence to the model. The model performs inference using a transformer-based architecture, computing attention weights and generating output tokens step by step according to a decoding strategy.

Input: prompt sentence text.

Processing: tokenization, embedding lookup, transformer-layer computations, autoregressive decoding.

Output: generated output text containing evaluation results and improvement proposals.

### Step 10:

Server parses the generated output into structured data.

Server scans the generated output text for predefined labels such as “Legal risk level:”, “Security risk level:”, “Customer satisfaction prediction:”, and “Improvement proposals:”.

Server extracts the corresponding values, converts textual risk descriptions into coded levels, and organizes proposals into a list of records with category tags.

Input: generated output text from the generative AI model.

Processing: string search, substring extraction, pattern matching, code conversion, record creation.

Output: structured data object including legal risk level, security risk level, customer satisfaction prediction, and categorized improvement proposals.

### Step 11:

Server generates sorting information based on structured data.

Server applies a mapping function that uses combinations of risk levels and proposal categories to determine target departments or processing entities. For example, server maps a high legal risk level related to regulation violations to a compliance entity, and maps a high security risk level related to network threats to a security operations entity.

Input: structured data object (risk levels and proposal categories).

Processing: lookup of routing rules, evaluation of mapping conditions, assignment of target department identifiers.

Output: sorting information specifying at least one department or processing entity to which the information is to be allocated.

### Step 12:

Server generates priority information considering emotion and risk.

Server combines the emotion label and emotion intensity with the legal and security risk levels to compute a processing priority value. For instance, server raises the priority when both risk levels and emotion intensity are high, and reduces the priority when both are low.

Server also generates an explanation sentence tailored to the emotion label, adjusting wording to reassure an anxious user or to moderate an angry user.

Input: emotion information, structured data object (including risk levels and satisfaction prediction).

Processing: numerical combination of risk levels and emotion intensity, threshold comparison, priority assignment, template-based explanation generation.

Output: priority information including processing priority and an emotion-adapted explanation sentence.

### Step 13:

Server composes control information and a response to the terminal.

Server bundles the sorting information and priority information into a control information object. Server also composes a response payload that includes the control information and user-facing content such as risk summaries and improvement proposals.

Input: sorting information, priority information, structured data object.

Processing: object construction, association of control fields with user-facing text, serialization.

Output: response payload including control information and explanation text.

### Step 14:

Terminal receives the response and updates the user interface.

Terminal deserializes the response payload, extracts risk levels, improvement proposals, and explanation sentences, and renders them on the display in a structured layout. Terminal may highlight items with high priority and present recommended actions as interactive elements.

Input: response payload from the server.

Processing: deserialization, UI state update, layout rendering, event binding for action buttons.

Output: visual display of risk assessments, proposals, and explanations on the terminal.

### Step 15:

User reviews the displayed information and provides feedback or selects actions.

User reads the explanation sentence, inspects the recommended improvement proposals, and may select options such as “accept recommendation”, “request more detail”, or “defer”.

Input: visual information presented on the terminal.

Processing (by user): comprehension and decision-making; (by terminal): capture of user selections and feedback.

Output: feedback data and action selections ready to be sent back to the server.

### Step 16:

Terminal transmits feedback and updated context to the server.

Terminal packages user feedback, accepted or rejected proposals, and any new user text into an updated information object and sends it to the server over the network connection.

Input: user feedback data and action selections.

Processing: aggregation into an update object, serialization, secure transmission.

Output: feedback payload received by the server.

### Step 17:

Server refines analysis and proposals based on feedback.

Server integrates the feedback with the existing case record, updates evaluation indicators if necessary, and constructs a new prompt sentence that includes a history of accepted and rejected proposals, the user's new questions, and the updated emotional state. Server repeats invocation of the generative AI model and subsequent parsing and structuring to produce refined proposals.

Input: feedback payload, existing normalized user information, reference context, prior structured data, updated emotion information.

Processing: record update, recomputation of indicators if needed, new prompt sentence construction, generative AI inference, parsing of new output.

Output: refined structured data, updated sorting information, and updated priority information.

### Step 18:

Server and terminal cooperate to complete routing and execution.

Server issues control commands to internal processing systems or queues using the sorting information and priority information, while terminal presents final recommendations and, where applicable, triggers device-level actions (such as opening configuration screens or initiating secure connections) in response to user selections.

Input: final control information, refined structured data, user selections.

Processing: command dispatch to internal systems, UI-driven invocation of local actions on the terminal.

Output: routed information in appropriate processing channels, updated device state when local actions are executed, and final confirmation presented to the user.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

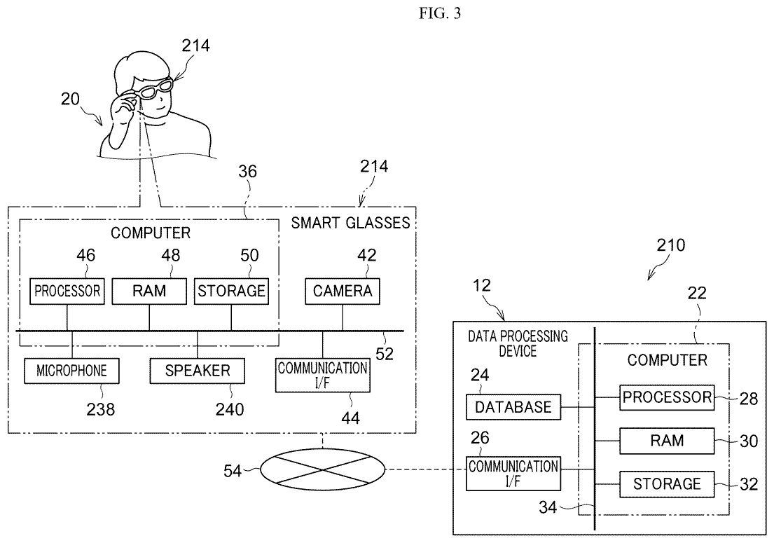

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

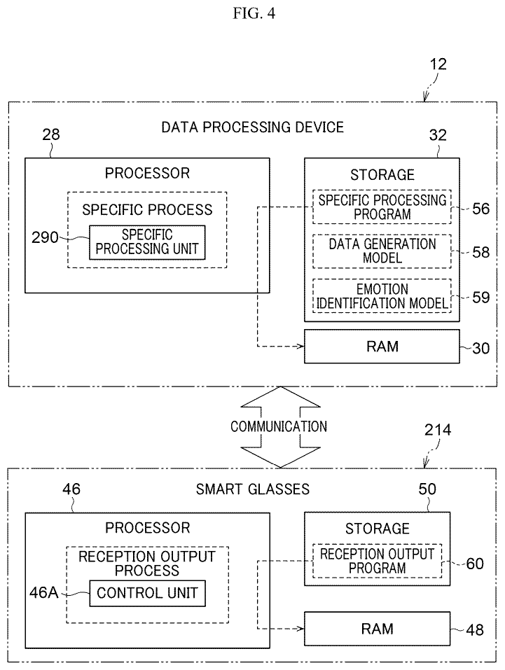

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

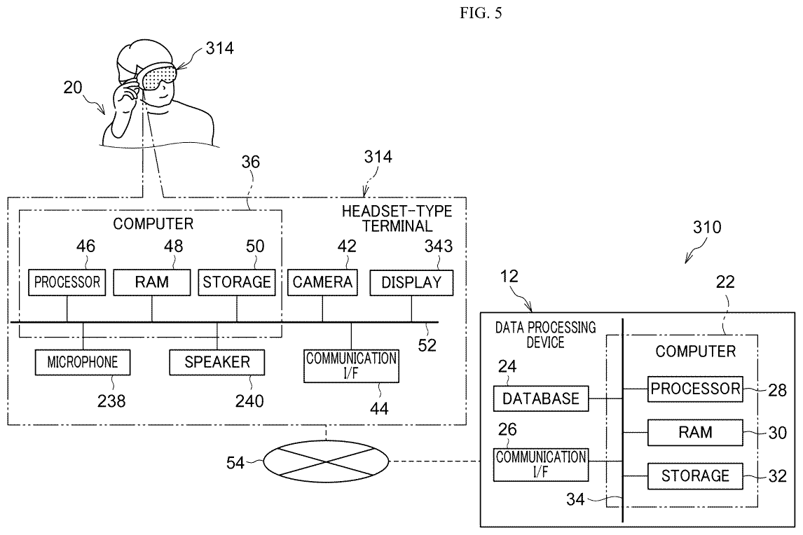

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication i/F 44 and the communication i/F 26.

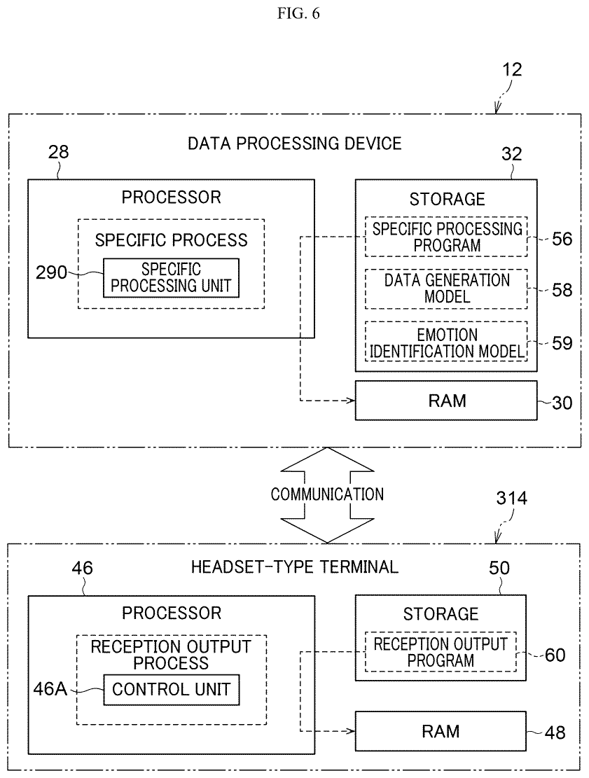

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

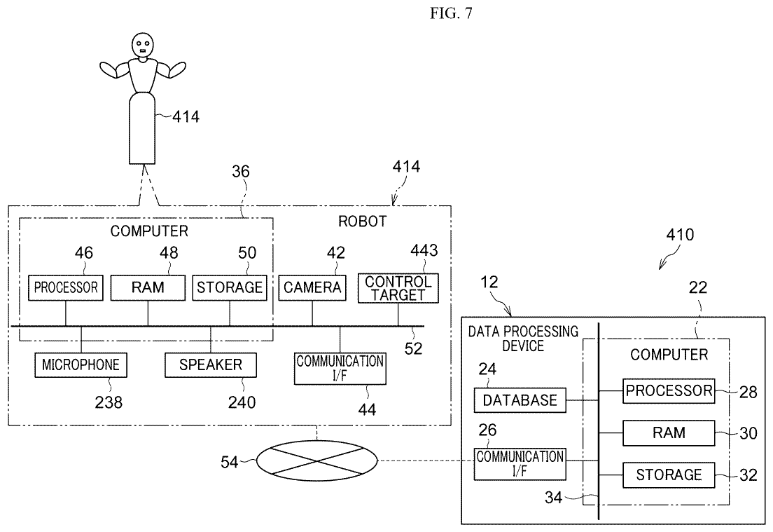

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

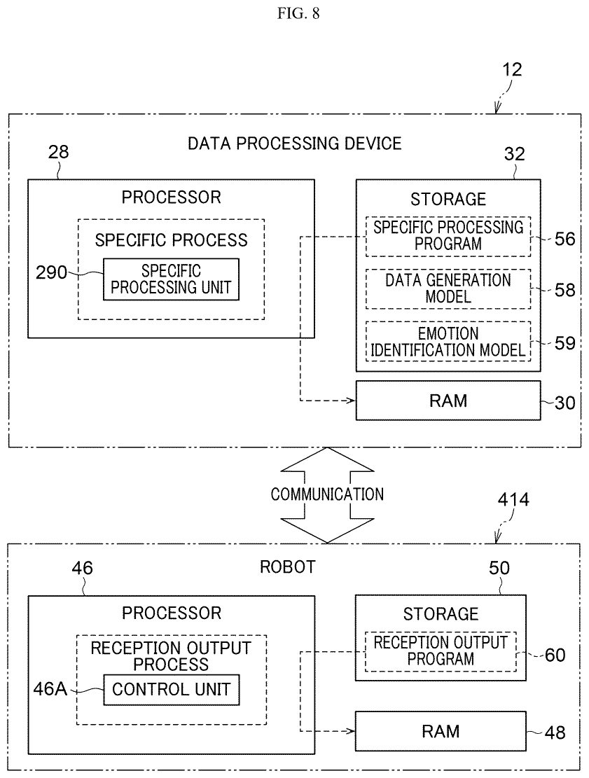

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

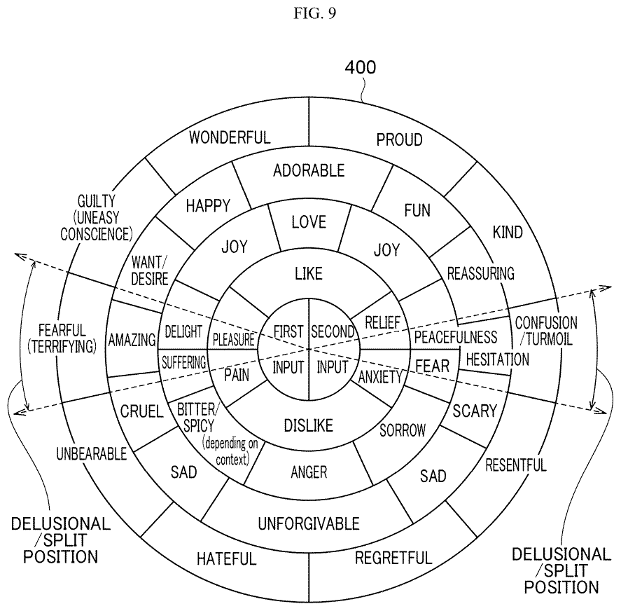

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

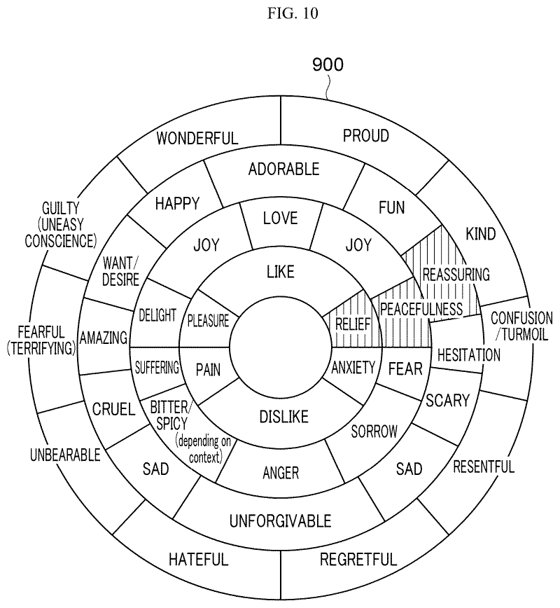

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via an input/output interface, request information regarding a case from a user, the request information including at least a case purpose, a target area, and constraint conditions, acquire, via a communication interface, case-related information from external information sources and internal information sources, the case-related information including at least legal system information, market information, and past case information, and store the acquired case-related information in a storage unit as an integrated data set associated with the case, preprocess textual information included in the data set by using generic natural language processing software, the preprocessing including at least segmentation, part-of-speech tagging, phrase extraction, and classification, and generate structured information indicating legal matters, information protection impact, user reactions, and business opportunities, generate context information by summarizing, based on the structured information, key points of the legal matters, key points of the information protection impact, and key points of the user reactions and market conditions,
generate a prompt sentence as a generation instruction text for creation of a proposal document, the prompt sentence being generated based on the request information and the context information and being configured to instruct generation of the proposal document in consideration of the legal matters, the information protection impact, and the user reactions so as to reduce risks and maximize advantages,
cause a generative artificial intelligence model based on machine learning to operate using the prompt sentence and the context information as inputs, and obtain generated information including the proposal document,
store the generated information in the storage unit in association with the case, and transmit the generated information to a terminal device via the input/output interface so that the user can view and edit the generated information, and
update the proposal document based on modification information received from the terminal device from the user, and adjust at least one of the prompt sentence and input conditions to the generative artificial intelligence model by using the modification information.

### (Supplementary 2)

The system according to supplementary 1,
wherein the processor is configured to
calculate, from the structured information, an importance degree for each of the legal matters, the information protection impact, and the user reactions, and automatically determine a configuration and output requirements of the prompt sentence such that at least elements having a high importance degree are preferentially included.

### (Supplementary 3)

The system according to supplementary 1,
wherein the processor is configured to
automatically divide the proposal document into sections according to a predetermined chapter structure or item structure and store respective components in the storage unit in association with the case, and, when an improvement request for a specific component is received from the user, generate a local prompt sentence targeting only the specific component, operate the generative artificial intelligence model again using the local prompt sentence, and partially regenerate the specific component so as to incrementally update the proposal document.

### Application Example 1

### (Supplementary 1)

A system comprising a processor,
wherein the processor is configured to
receive, via an input/output device, case information in natural language from a user, perform, by using a natural language processing technique, character string preprocessing, tokenization, sentence segmentation, and language identification on the received case information so as to convert the case information into analysis data,
extract, based on the analysis data, terms relating to regulatory requirements, technical issues, and market environment factors, and classify the terms into at least one category including a regulation category, a technology category, and a market category so as to generate structured data,
organize, based on the structured data, an analysis result including a purpose of a case, the regulatory requirements, the technical issues, and the market environment factors, and generate a prompt sentence for inputting the analysis result to a generative AI model, operate the generative AI model by using the prompt sentence so as to generate a draft project proposal document based on the analysis result,
format the draft project proposal document into a document structure having at least one section including a case overview, legal concerns, security impacts, customer reactions, market environment, risk reduction measures, and advantages of the case,
store the draft project proposal document and the document structure in a storage device, and transmit the draft project proposal document to a user terminal via the input/output device, update the prompt sentence based on correction information or additional instructions for the draft project proposal document received from the user terminal, and regenerate the project proposal document by using the generative AI model with the updated prompt sentence so as to iteratively revise the project proposal document and generate a final version, and
transmit the final version of the project proposal document to the user terminal and convert the final version into a predetermined document format for output.

### (Supplementary 2)

The system according to supplementary 1,
wherein the processor is configured to
generate a prompt sentence, based on the structured data and the draft project proposal document including the legal concerns, the security impacts, and the customer reactions, for automatically allocating information to responsible departments in an organization, and determine the responsible departments by inputting the prompt sentence to the generative AI model.

### (Supplementary 3)

The system according to supplementary 1,
wherein the processor is configured to
calculate an emotional state by applying an emotion analysis technique to input information from the user, generate a prompt sentence for setting a priority of the information based on the calculated emotional state and the structured data, and control, according to the priority, at least one of an allocation order of the information and a degree of emphasis in proposal content by inputting the prompt sentence to the generative AI model.

### Example 2

### (Supplementary 1)

A system comprising a processor,
wherein the processor is configured to
receive, via an input/output device, case information from a user, the case information including at least specification information of an article or a service, market information of a target domain, regulation information of a relevant norm, and past reaction information, store the received case information in a storage device, perform natural language processing on character information included in the case information, and extract important terms and a type of the relevant norm,
search an information storage device storing a set of law information, a set of security requirement information, and a set of reaction information, based on the extracted important terms and the type of the relevant norm, and acquire a plurality of reference information items related to the case,
convert the case information and the reference information items into numerical representations, calculate relatedness between the case information and each reference information item based on the numerical representations, and select high-relatedness reference information items based on a predetermined threshold or ranking,
generate a prompt sentence including the selected reference information items and the case information, the prompt sentence being configured to cause a generative information processing model to evaluate at least one of a legal concern, a security impact, and a customer reaction,
input the prompt sentence to the generative information processing model and acquire output information from the generative information processing model, the output information including an analysis result relating to at least one of the legal concern, the security impact, and the customer reaction,
analyze the acquired output information to generate, as structured data, a plurality of evaluation indices corresponding to a legal risk, a security risk, and a customer evaluation, and calculate a comprehensive risk evaluation value of the case based on the plurality of evaluation indices,
generate report information including a plurality of items corresponding to the legal concern, the security impact, and the customer reaction, based on the analysis result and the comprehensive risk evaluation value, and add, to the report information, a section structure including an improvement proposal for the case,
output the generated report information to a display device or a recording device for presentation to the user,
generate a prompt sentence for sorting the report information or the case information for each organizational division, by determining, using the generative information processing model, a relevant organizational division from the analysis result,
and generate a prompt sentence for controlling an order of sorting processing or an order of notification, by performing emotion analysis processing on input information or response information related to the user, calculating priority information indicating a priority of the case or information based on a result of the emotion analysis processing, and using the priority information.

### (Supplementary 2)

The system according to supplementary 1,
wherein the processor is configured to
include, in the prompt sentence input to the generative information processing model, structure designation information that specifies an output format of the report information such that items of the legal concern, the security impact, the customer reaction, and the improvement proposal are distinguished, and acquire, from the generative information processing model, the analysis result having a section structure in accordance with the structure designation information.

### (Supplementary 3)

The system according to supplementary 1,
wherein the processor is configured to
calculate similarity between the numerical representations representing the case information and the reference information items when calculating the relatedness, select the reference information items based on the similarity, and control an amount of information input to the generative information processing model by including only the selected reference information items in the prompt sentence.

### Application Example 2

### (Supplementary 1)

A system comprising a processor,
wherein the processor is configured to
receive, via an information input/output interface, information from a user including transaction information or case information,
normalize the received information and acquire, from a storage device or an external information source, regulation information, security requirement information, and user reaction information related to the received information, and integrate the acquired information as reference context,
perform preliminary evaluation processing in accordance with a rule set based on the received information and the reference context, and calculate at least one evaluation indicator related to legal concern, security impact, and customer reaction,
identify an emotional state of the user by using emotion analysis technology based on the information from the user and additional information to be analyzed, and generate emotion information including an emotion label and an emotion intensity,
generate a prompt sentence including the information from the user, the reference context, a result of the preliminary evaluation processing, and the emotion information, and provide the prompt sentence as input to a generative artificial intelligence model,
input the prompt sentence into the generative artificial intelligence model and execute inference processing to cause the generative artificial intelligence model to generate output information including an evaluation result related to the legal concern, the security impact, and the customer reaction, and including an improvement proposal,
analyze the output information obtained from the generative artificial intelligence model, extract structured data representing at least a legal risk level, a security risk level, a customer satisfaction prediction, and the improvement proposal, and generate sorting information for specifying a department or processing entity that is a target to which the information is to be allocated,
generate priority information including an explanation sentence adapted to the emotional state of the user and a processing priority of the information based on the emotion information and the structured data, and generate control information for ordering processing
of the information in accordance with the priority information, and output a prompt sentence or a control command including the sorting information and the priority information, the prompt sentence or the control command being for allocating the information to an appropriate department or processing entity and for setting the processing priority of the information.

### (Supplementary 2)

The system according to supplementary 1,
wherein the processor is configured to
control the prompt-sentence generation to generate, as the prompt sentence, an instruction sentence for automatically causing the generative artificial intelligence model to determine a department or processing entity in charge of the information based on content extracted from the information from the user and the reference context, and to cause the generative artificial intelligence model to generate the sorting information.

### (Supplementary 3)

The system according to supplementary 1,
wherein the processor is configured to
generate, as the control information, a prompt sentence or a control command for dynamically changing the processing priority of the information in accordance with at least one of anxiety, anger, and satisfaction of the user, based on the emotion label and the emotion intensity included in the emotion information and based on the risk level included in the structured data, and to control an order of sorting or a processing procedure of the information by using the prompt sentence or the control command.

What is claimed is:

1. A system comprising:
circuitry configured to:
receive natural language input data from a terminal;
perform natural language preprocessing on the natural language input data by applying character string normalization, tokenization, sentence segmentation, and language identification to generate analysis data;
apply a multi-label classification model to the analysis data to extract terms and classify the extracted terms into at least a regulation category, a technology category, and a market category to generate structured category data;
generate a first prompt sentence by serializing an analysis result derived from the structured category data into a structured prompt template that encodes the regulation category terms, the technology category terms, the market category terms, and section-specific instruction tokens constraining output scope;
input the first prompt sentence to a generative artificial intelligence model to generate a structured document comprising at least a legal concerns section, a security impacts section, a customer reactions section, and a risk reduction measures section;
generate a second prompt sentence encoding a multi-dimensional feature vector derived from the legal concerns section, the security impacts section, and the customer reactions section; and
input the second prompt sentence to the generative artificial intelligence model to generate an organizational assignment result identifying processing units corresponding to the multi-dimensional feature vector.

2. The system of claim 1, wherein the circuitry is configured to:
apply an emotion analysis technique to input information from the terminal to calculate an emotional state;
generate a priority prompt sentence based on the calculated emotional state and the structured category data; and
input the priority prompt sentence to the generative artificial intelligence model to control at least one of an allocation order of the natural language input data and a degree of emphasis in document content according to a determined priority.

3. The system of claim 2, wherein the emotion analysis technique applies at least one of a lexicon-based scoring algorithm, a recurrent neural network classifier, or a transformer-based sentiment model to compute an emotional state score from natural language expressions in the input information.

4. The system of claim 3, wherein the emotional state score is normalized to a numerical value and incorporated into the priority prompt sentence as an additional embedding parameter that adjusts a priority rank of the natural language input data relative to other pending inputs.

5. The system of claim 4, wherein the circuitry is configured to:
receive correction information or additional instructions for the structured document from the terminal;
update the first prompt sentence based on the correction information or additional instructions; and
input the updated first prompt sentence to the generative artificial intelligence model to regenerate the structured document and iteratively revise the structured document until a final version is produced.

6. The system of claim 1, wherein extracting terms and classifying the extracted terms comprises applying at least one of named entity recognition, keyword extraction, or co-reference resolution to the analysis data.

7. The system of claim 6, wherein the multi-label classification model is trained to assign category labels to terms based on their semantic context in the analysis data, enabling a single term to receive labels in multiple categories simultaneously.

8. The system of claim 1, wherein the section-specific instruction tokens constrain the generative artificial intelligence model to generate content scoped to each section independently, reducing cross-section content overlap in the structured document.

9. The system of claim 8, wherein the structured prompt template further includes an output format constraint specifying that the generative artificial intelligence model is to organize the structured document into sections indexed by section identifier, enabling programmatic extraction of section content.

10. The system of claim 1, wherein the circuitry is configured to:
validate the structured document against a predefined schema that specifies required sections and minimum content length constraints, and re-input a revised first prompt sentence to the generative artificial intelligence model when validation fails.

11. The system of claim 1, wherein generating the multi-dimensional feature vector comprises applying a term frequency-inverse document frequency weighting algorithm or a semantic embedding algorithm to content extracted from the legal concerns section, the security impacts section, and the customer reactions section.

12. The system of claim 4, wherein the circuitry is configured to:
weight dimensions of the multi-dimensional feature vector based on the emotional state score, such that dimensions associated with urgency indicators receive higher weights when the emotional state score indicates elevated stress.

13. The system of claim 1, wherein the generative artificial intelligence model is a transformer-based large language model accessed via a network interface, and wherein inputting prompt sentences comprises transmitting prompt request payloads via an application programming interface.

14. The system of claim 1, wherein natural language preprocessing further comprises applying stop-word removal and stemming to the analysis data prior to term extraction.

15. The system of claim 2, wherein the emotional state comprises at least one of a positive state, a negative state, a neutral state, an anxious state, and an urgent state.

16. The system of claim 1, wherein storing the structured document comprises persisting the structured document in a structured storage format that associates section content with section identifiers for retrieval and revision.

17. The system of claim 5, wherein iteratively revising the structured document comprises tracking revision history by storing successive versions of the structured document, each version associated with a revision timestamp and a summary of applied corrections.

18. A system comprising:
circuitry configured to:
receive natural language input data from a terminal and perform natural language preprocessing including tokenization, sentence segmentation, and language identification to generate analysis data;
apply a multi-label classification model to the analysis data to classify extracted terms into at least a regulation category, a technology category, and a market category to generate structured category data;
generate a first prompt sentence serializing an analysis result derived from the structured category data and input the first prompt sentence to a generative artificial intelligence model to generate a structured document having predefined sections;
apply an emotion analysis technique to input information from the terminal to calculate an emotional state and generate a priority prompt sentence based on the emotional state and the structured category data; and
input the priority prompt sentence to the generative artificial intelligence model to control at least one of an allocation order and a degree of emphasis in document content according to a determined priority.

19. The system of claim 18, wherein the circuitry is configured to apply the multi-label classification model to assign the regulation category, the technology category, and the market category to extracted terms, and to incorporate the resulting structured category data into the first prompt sentence as structured embedding fields alongside section-specific instruction tokens.

20. A method performed by circuitry, the method comprising:
receiving natural language input data from a terminal;
performing natural language preprocessing on the natural language input data by applying character string normalization, tokenization, sentence segmentation, and language identification to generate analysis data;
applying a multi-label classification model to the analysis data to extract terms and classify the extracted terms into at least a regulation category, a technology category, and a market category to generate structured category data;
generating a first prompt sentence by serializing an analysis result derived from the structured category data into a structured prompt template encoding section-specific instruction tokens;
inputting the first prompt sentence to a generative artificial intelligence model to generate a structured document comprising at least a legal concerns section, a security impacts section, and a customer reactions section;
applying an emotion analysis technique to input information to calculate an emotional state and generating a priority prompt sentence based on the emotional state and the structured category data; and
inputting the priority prompt sentence to the generative artificial intelligence model to control at least one of an allocation order and a degree of emphasis in document content.
